(19) United States
(12) Patent Application Publication
(10) Pub. No.: US 2026/0222922 A1
(43) Pub. Date: Jul. 30, 2026

(54) METHOD AND APPARATUS FOR HANDLING UE CONTEXT FOR SATELLITE COMMUNICATION

(71) Applicant: SAMSUNG ELECTRONICS CO., LTD., Suwon-si (KR)

(72) Inventors: Sidhant JAIN, Bangalore (IN); Lalith KUMAR, Bangalore (IN); Aman AGARWAL, Bangalore (IN); Dinesh Rooparam CHOUDHARY, Bangalore (IN)

(21) Appl. No.: 19/573,276

(22) Filed: Mar. 20, 2026

Related U.S. Application Data
(63) Continuation of application No. PCT/KR2024/014293, filed on Sep. 23, 2024.

(30) Foreign Application Priority Data
Sep. 28, 2023 (IN) 202341065332
Sep. 6, 2024 (IN) 202341065332

(51) Int. Cl. H04W 36/00; H04W 36/08; H04W 60/04; H04W 64/00; H04W 84/06

(52) U.S. Cl. CPC H04W 36/0033; H04W 36/08; H04W 60/04; H04W 64/00; H04W 84/06

(57) ABSTRACT

A method for handling, by a mobility management entity (MME)-ground, a user equipment (UE) context for satellite communication is provided. The method may comprise maintaining a UE context for a UE based on the UE registering with a network entity. The method may comprise identifying at least one first MME-onboard each of which is in a corresponding satellite having possibility to serve the UE. The method may comprise sharing the UE context stored at the MME-ground with the at least one identified first MME-onboard.

### CROSS-REFERENCE TO RELATED APPLICATIONS

This application is a continuation of International Application No. PCT/KR2024/014293 designating the United States, filed on Sep. 23, 2024, in the Korean Intellectual Property Receiving Office and claiming priority to Indian Provisional Patent Application No. 202341065332, filed on Sep. 28, 2023, and Indian Complete patent application No. 202341065332, filed on Sep. 6, 2024, in the Indian Patent Office, the disclosures of each of which are incorporated by reference herein in their entireties.

### BACKGROUND

### Field

The disclosure relates to satellite communications, and more particularly to a method and a system for handling a User Equipment (UE) context for satellite communication.

### Description of Related Art

A Store and Forward (S&F) satellite operation in a fifth generation (5G) system with satellite access is intended to provide some level of communication service for UEs under satellite coverage with intermittent/temporary satellite connectivity (e.g., when the satellite is not connected via a feeder link or via an Intersatellite Link (ISL) to a ground network (106)) for delay-tolerant communication service. An example of a “S&F Satellite operation” is illustrated in FIG. 1 and FIG. 2, in contrast to what could be considered the current assumption for a “normal/default satellite operation” of a 5G system with satellite access.

As shown in FIG. 1 and FIG. 2, under “normal/default Satellite operation” mode, signalling and data traffic exchange between a UE (102) with satellite access and the remote ground network (106) requires the service and feeder links to be active simultaneously, so that, at the time that the UE (102) interacts over the service link with the satellite (104), there is a continuous end-to-end connectivity path between the UE (102), the satellite (104) and the ground network (106). In contrast, under “S&F Satellite operation” mode, the end-to-end exchange of signalling/data traffic is now managed as a combination of two steps not_concurrent in time (steps A and B). In step A, signalling/data exchange between the UE (102) and the satellite (104) takes place, without the satellite (104) being simultaneously connected to the ground network (106) (e.g., the satellite (104) is able to operate the service link without an active feeder link connection). In step B, connectivity between the satellite (104) and the ground network (106) is established so that communication between the satellite (104) and the ground network (106) can take place. So, the satellite (104) moves from being connected to the UE (102) in step A to being connected to the ground network (106) in step B. The concept of “S&F” service is widely used in the fields of delay-tolerant networking and disruption-tolerant networking. In 3^{rd} Generation Partnership Project (3GPP) context, a service that could be assimilated to an S&F service is Short Message Service (SMS), for which there is no need to have an end-to-end connectivity between the endpoints (for example, an end-point can be the UE (102) and the other an application server) but only between the end-points and a short message service center (SMSC) which acts as an intermediate node in charge of storing and relying. The support of the S&F Satellite operation is especially suited for the delivery of delay-tolerant/non-real-time Internet of Things (IoT) satellite services with Non-Geostationary Orbit (NGSO) satellites.

Further, the 5G or fourth generation (4G) System with Satellite access may support Store and Forward mechanism (e.g., S&F operating mode or mechanism) when the feeder link is not available or at least one of the service link and feeder link is not available simultaneously for the serving satellite (104) at the current UE location. However, how the current 5G or 4G System with the satellite access will handle the Store and Forward (S&F) mode or mechanism is not defined and needs to be defined. Moreover, how the network (e.g., 5G or 4G System with Satellite Access) handle the connection management for the UE(s) (102) when the feeder link is not available or at least one of the service link and feeder link is not available simultaneously is not defined and needs to be defined.

In prior art, the UE (102) registers with static MME entity of the network, so there was one to one relationship. Static MME used to manage the UE context on the network. Thus, the UE (102) can get the services. For NTN, the satellite (104) is not a static entity, it keeps moving around the globe. Also, once the satellite-1 moves away from the UE service area, the satellite-2 will start serving the UE (102) in a given UE location later satellite-3 will serve the UE (102). This implies that all this satellites should have the UE context so that same UE can be serviced. This gives rise for a need of distributed UE context storage across all the MMEs which will serve the UE (102). Such distributed UE context management was not discussed in the prior art.

Hence, there is a need in the art for solutions which will address the above mentioned drawback(s), among others.

### SUMMARY

Embodiments of the disclosure provide an architecture for cellular communication networks with satellite access.

Embodiments of the disclosure manage a distributed UE context for satellite communication.

Embodiments of the disclosure provide an architecture option for a new radio (NR) satellite access to support S&F services is defined, there are N Mobility Management Entity (MME) instances called as MME-onboard deployed and one anchor MME-ground.

Embodiments of the disclosure provide an MME-ground configured with potential MME-onboard(s) which can serve the UE based on a UE serving area.

Embodiments of the disclosure provide an MME-ground as an anchor node situated in a ground network which has the UE context. The MME-ground synchronizes the UE context with all the MME-onboard(s).

Embodiments of the disclosure provide that when a procedure is initiated by the UE, the MME-onboard stores a Non Access Stratum (NAS) message received from the UE because there is no feeder link, it is forward to the MME-ground when feeder link is available. The MME-ground executes procedure and creates the UE context. The MME-ground then synchronizes the UE context with all the MME-onboard(s).

Embodiments of the disclosure provide an architecture for cellular communication networks with satellite access, wherein the 5G or 4G system with Satellite access (e.g., the Satellite Network) may support store and forward mechanism (e.g., S&F operating mode or mechanism) when the feeder link is not available or at least one of the service link and the feeder link is not available simultaneously for the serving satellite at the current UE location.

Embodiments of the disclosure provide an architecture for cellular communication networks with satellite access, wherein the satellite network may have e-NodeB (eNB)/g-NodeB (gNB) onboard and/or MME/AMF-Onboard (for 4G/5G system with Satellite Access) (or similarly gNB and access and mobility management function (AMF)/User Plane Function (UPF) UPF/any other Network Function or entities onboard for 4G/5G system with Satellite Access) present onboard the Satellite System (e.g., the serving Satellite).

Embodiments of the disclosure provide an architecture for cellular communication networks with satellite access, wherein the eNB/gNB present on/onboard the Satellite System (for example, eNB-Onboard/gNB-Onboard) shall act as the RAN Entity for the UE and shall provide the RAN capability to the UE, on behalf of the Satellite Network, optionally when the feeder link is available/not available or when at least one of the service link and feeder link is not available simultaneously.

Embodiments of the disclosure provide an architecture for cellular communication networks with satellite access, wherein the MME/AMF-Onboard present on the Satellite System shall act as a temporary MME/AMF or a proxy MME/AMF for the UE, optionally when the feeder link is not available or when the Satellite is not connected to the ground Network or to the MME/AMF on the ground and the MME/AMF-Onboard may provide Store and Forward functionalities for the UE and may also provide some/all EMM Connection Management Procedures (S1 mode only) like Service Request Procedure (e.g., to support to bring the UE into CM-CONNECTED mode), paging procedure, Transport of NAS messages, generic transport of NAS messages and other similar procedures.

Embodiments of the disclosure provide an architecture for cellular communication networks with satellite access, wherein the MME/AMF-Onboard may be connected to the MME/AMF (on ground) via the existing S10 interface or a new interface (Sxx) may be supported to connect MME/AMF-Onboard with the MME/AMF (on ground) for information/message transfer, wherein the New Interface (Sxx) may have some additional security protection for secure exchange of information/messages between MME/AMF-Onboard and the MME/AMF (on ground) and the MME/AMF-Onboard may forward the messages/information from/for the UE to the MME/AMF (on ground), optionally when feeder link is available, and vice-versa, without any additional security protection.

Embodiments of the disclosure provide an architecture for cellular communication networks with satellite access, wherein the eNB/gNB present on/onboard the Satellite System, if present, may be connected to the MME/AMF-Onboard via the existing S1-MME/AMF interface or a new interface (S1-yy) may be supported to connect MME/AMF-Onboard with the eNB (on board) for information/message transfer, wherein the New Interface (S1-yy) may have some additional security protection for secure exchange of information/messages between MME/AMF-Onboard and the eNB/gNB (OnBoard) and the eNB/gNB-Onboard may forward the messages/information from/for the UE to the MME/AMF-OnBoard, optionally when feeder link is not available, and vice-versa, without any additional security protection.

These and other aspects of the disclosure will be better appreciated and understood when considered in conjunction with the following description and the accompanying drawings. It should be understood, however, that the following descriptions, while indicating various example embodiments and numerous specific details thereof, are given by way of illustration and not of limitation. Many changes and modifications may be made within the scope of the various embodiments herein without departing from the spirit thereof, and the disclosure includes all such modifications.

According to an example embodiment of the present disclosure, a method for handling, by a mobility management entity (MME)-ground, a user equipment (UE) context for satellite communication is provided. The method may comprise: maintaining a UE context for a UE based on the UE registering with a network entity; identifying at least one first MME-onboard each of which is in a corresponding satellite capable of serving the UE; and sharing the UE context stored at the MME-ground with the at least one identified first MME-onboard.

The MME-ground may support a store and forward service in the satellite communication based on the synchronized UE context.

The at least one first MME-onboard may be identified based on a location of the UE.

The UE context, stored at the MME-ground, may be shared in response to determining that a feeder link is established between the MME-ground and the at least one first MME-onboard, where the feeder link is a communication link between a onboard entity of a satellite and a ground network.

The method may comprise detecting that the UE context has changed from a first UE context to a second UE context. The method may comprise identifying at least one second MME-onboard each of which is in a corresponding satellite having possibility to serve the UE, based on the detection. The method may comprise sharing the second UE context stored at the MME-ground with the at least one identified second MME-onboard.

The method may comprise detecting a change in a UE serving area. The method may comprise identifying at least one third MME-onboard each of which is in a corresponding satellite having possibility to serve the UE based on the detection. The method may comprise sharing the UE context stored at the MME-ground with the at least one identified third MME-onboard.

The method may comprise detecting a change in a UE serving area. The method may comprise identifying at least one fourth MME-onboard each of which is in a corresponding satellite having possibility not to serve the UE based on the detection. The method may comprise deleting the UE context shared at the at least one identified fourth MME-onboard.

An MME-onboard may act as a slave node to the MME-ground. The MME-ground may have an address of a subset of the at least one MME-onboard. The at least one MME-onboard may serve the UE based on a location of the UE.

The MME-ground may be an anchor node situated in a ground network which has the UE context. The MME-ground may synchronize the UE context with the at least one first MME-onboard.

The MME-ground may be locally configured with information that indicates which the MME-onboard will serve in the serving area of the UE (102). The MME-ground may be configured by at least one of: an operations and maintenance (O&M) entity and an Application Function (AF) entity through a service capabilities exposure function (SCEF) path.

The UE context may be created or changed in the at least one first MME-onboard. The UE context may be synchronized with the at least one first MME-onboard, when the at least one MME-onboard connects with a ground network.

According to an example embodiment of the present disclosure, an apparatus for a mobility management entity (MME)-ground for handling a user equipment (UE) context for satellite communication is provided. The apparatus may comprise: memory storing instructions; at least one processor, comprising processing circuitry, wherein the instructions, when executed by the at least one processor, individually and/or collectively, cause the apparatus to: maintain a UE context for a UE based on the UE registering with a network entity; identify at least one first MME-onboard each of which is in a corresponding satellite capable of serving the UE; and share the UE context stored at the MME-ground with the at least one identified first MME-onboard.

According to an example embodiment of the present disclosure, a non-transitory computer-readable storage medium storing instructions is provided. The instructions, when executed by at least one processor, comprising processing circuitry, of an apparatus for a mobility management entity (MME)-ground, individually and/or collectively, may cause the apparatus to: maintain a UE context for a UE based on the UE registering with a network entity; identify at least one first MME-onboard each of which is in a corresponding satellite capable of serving the UE; and share the UE context stored at the MME-ground with the at least one identified first MME-onboard.

### BRIEF DESCRIPTION OF THE DRAWINGS

Embodiments herein are illustrated in the accompanying drawings, throughout which like reference letters indicate corresponding parts in the various figures. The above and other aspects, features and advantages of certain embodiments of the present disclosure will be more apparent from the following detailed description, taken in conjunction with the accompanying drawings, in which:

FIG. 1 and FIG. 2 illustrating an example of “S&F Satellite operation”, according to the prior art;

FIG. 3 is a diagram illustrating an example architecture for enabling operation of cellular communication networks with satellite access, according to various embodiments;

FIG. 4A and FIG. 4B are signal flow diagrams illustrating an example process of transferring the UE context, according to various embodiments;

FIG. 5 is a block diagram illustrating an example configuration of an MME-ground, according to various embodiments;

FIG. 6 is a flowchart illustrating an example method for handling a UE context for satellite communication, according to various embodiments; and

FIG. 7 is a block diagram illustrating example 4G satellite architecture for distributed UE context management, according to various embodiments.

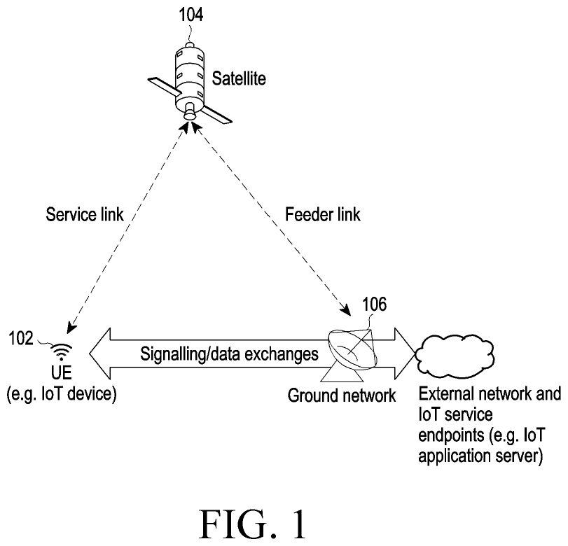

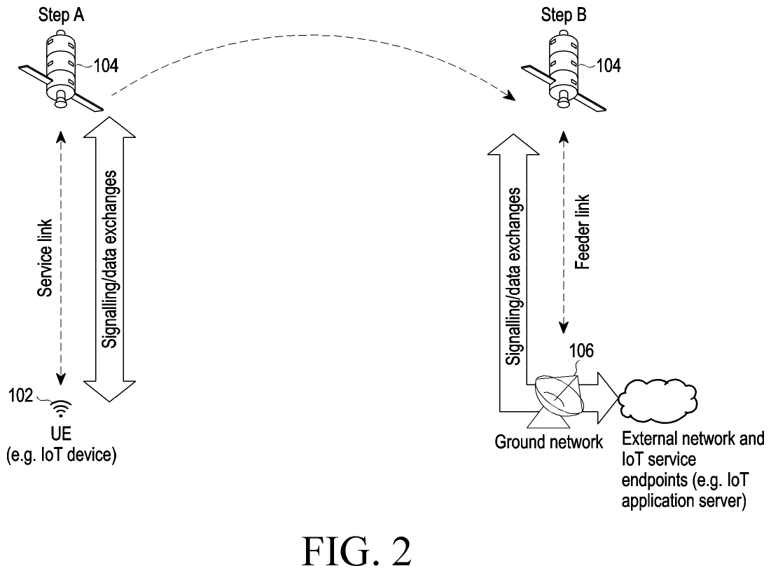

Table 1 to Table 9 in the following disclosure illustrate the UE context, wherein at least one of the parameters/fields is stored in the onboard/ground AMF/MME, according to various example embodiments.

### DETAILED DESCRIPTION

The various example embodiments herein and the various features and details thereof are explained more fully with reference to the non-limiting embodiments that are illustrated in the accompanying drawings and detailed in the following description. Descriptions of well-known components and processing techniques may be omitted so as to not unnecessarily obscure the various example embodiments herein. The examples used herein are intended merely to facilitate an understanding of ways in which the various example embodiments herein may be practiced and to further enable those of skill in the art to practice the various embodiments herein. Accordingly, the examples should not be construed as limiting the scope of the disclosure.

The words/phrases “exemplary”, “example”, “illustration”, “in an instance”, “and the like”, “and so on”, “etc.”, “etcetera”, “e.g.,”, “i.e.,” are merely used herein to refer to “serving as an example, instance, or illustration. Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Various embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits of a block may be implemented by dedicated hardware, or by a processor (e.g., one or more programmed microprocessors and associated circuitry), or by a combination of dedicated hardware to perform some functions of the block and a processor to perform other functions of the block. Each block of the various embodiments may be physically separated into two or more interacting and discrete blocks without departing from the scope of the disclosure. Likewise, the blocks of the various embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the various embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the various embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The various embodiments herein may provide a method for handling a UE context for satellite communication. The method includes maintaining, by an MME-ground, a UE context in response to a UE registering with a network entity. Further, the method includes identifying, by the MME-ground, at least one MME onboard in which a satellite serves the UE. Further, the method includes sharing, by the MME-ground, the UE context stored at the MME-ground with the at least one identified MME-onboard. Further, the method includes managing, by the MME-ground, the synchronized UE context on the at least one identified MME-onboard.

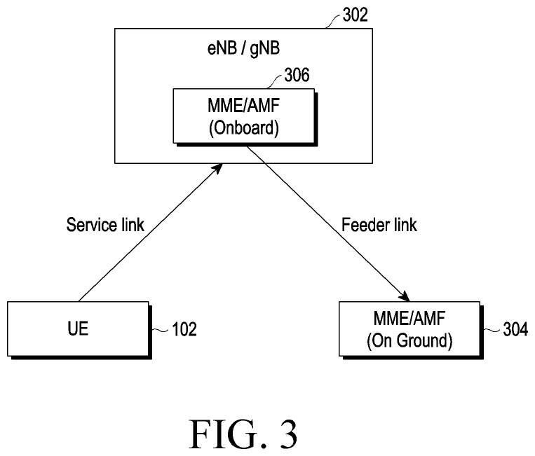

Referring now to the drawings, and more particularly to FIGS. 3 through 7, where similar reference characters denote corresponding features consistently throughout the figures, there are shown various example embodiments.

The following abbreviations and definitions have been disclosed herein:
3GPP: Third Generation Partnership Project
5GC: 5G Core
5GCN: 5G Core Network
5GMM: 5G Mobility Management
5GS: 5G System
AMF: Access and Mobility Management Function
AS: Access Stratum
AUSF: Authentication Server Function
CAG: Closed access group
CAG ID: Closed Access Group Identifier
CU: Centralized Unit
DC: Discontinuous Coverage
DisCo: Discontinuous Coverage
DL: Downlink
DU: Distributed Unit
EHPLMN: Equivalent Home Public Land Mobile Network
EMM: EUTRA Mobility Management
eNB: Evolved Node-B
EPS: Evolved Packet System
eSIM: embedded Subscriber Identity Module
E-UTRA: Evolved Universal Mobile Telecommunication Access
EUTRAN: Evolved Universal Mobile Telecommunication Access Network
FPLMN: Forbidden Public Land Mobile Network
GEO: Geostationary Orbit
gNB: Next generation Node-B
gNB-CU: Next generation Node-B Control Unit
gNB-DU: Next generation Node-B Distributive Unit
GPRS: General Packet Radio Service
HPLMN: Home Public Land Mobile Network
IAB: Integrated access and backhaul
IAB-UE: The part of the IAB node that supports the Uu interface towards the IAB-donor or another parent IAB-node (and thus manages the backhaul connectivity with either PLMN or SNPN it is registered with) is referred to as an IAB-UE.
LEO: Low Earth Orbit
MCC: Mobile Country Code
MEO: Medium Earth Orbit
MME/AMF: Mobility Management Entity
MNC: Mobile Network Code
MS: Mobile Station. The disclosure makes no distinction between MS and UE.
NAS: Non-Access Stratum
NG-RAN: Next Generation Radio Access Network
NPN: Non-Public Networks
NR: New Radio
NTN: Non Terrestrial Networks
NW: Network
OOS: Out of Service
PDN: Packet Data Network
PDU: Packet Data Unit
PLMN ID: Public Land Mobile Network Identity
RAT: Radio Access Technology
RPLMN: Registered Public Land Mobile Network
RRC: Radio Resource Control
SAT: Satellite
Satellite: An artificial body placed in orbit round the earth or moon or another planet in order to collect information or for communication.
Satellite Constellation: Group of satellites, placed in orbit round the earth or moon or another planet in order to collect information or for communication.
Service User: An individual who has received a priority level assignment from a regional/national authority (e.g., an agency authorized to issue priority assignments) and has a subscription to a mobile network operator
SIM: Subscriber Identity Module
SNPN: Standalone Non-Public Networks
TAU: Tracking Area Update
TER: Terrestrial
TN: Terrestrial Networks
UCU: UE Configuration Update
UDM: Unified Data Management Function
UE: User Equipment
UL: Uplink
UPU: UE Parameters Update
USIM: Universal Subscriber Identification Module
Uu: The radio interface between the UE and the Node B
VPLMN: Visited Public Land Mobile Network
WB-S1 Mode Wide Band with S1 Interface
Visited PLMN (VPLMN): This is a PLMN different from the HPLMN (if the EHPLMN list is not present or is empty) or different from an EHPLMN (if the EHPLMN list is present).
Allowable PLMN: In the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.
Available PLMN: PLMN(s) in the given area which is/are broadcasting capability to provide wireless communication services to the UE.
Camped on a cell: The MS (ME if there is no SIM) has completed the cell selection/reselection process and has chosen a cell from which it plans to receive all available services. Note that the services may be limited, and that the PLMN or the SNPN may not be aware of the existence of the MS (ME) within the chosen cell.
EHPLMN: Any of the PLMN entries contained in the Equivalent HPLMN list.
Equivalent HPLMN list: To allow provision for multiple HPLMN codes, PLMN codes that are present within this list shall replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list, then it shall be treated as a Visited PLMN for PLMN selection purposes.
Home PLMN: This is a PLMN where the MCC and MNC of the PLMN identity match the MCC and MNC of the IMSI.
Registered PLMN (RPLMN): This is the PLMN on which certain LR (location registration which is also called as registration procedure) outcomes have occurred. In a shared network the RPLMN is the PLMN defined by the PLMN identity of the CN operator that has accepted the LR.
Registration: This is the process of camping on a cell of the PLMN or the SNPN and doing any necessary LRs.
UPLMN: PLMN/access technology combination in the “User Controlled PLMN Selector with Access Technology” data file in the SIM (in priority order).
OPLMN: PLMN/access technology combination in the “Operator Controlled PLMN Selector with Access Technology” data file in the SIM (in priority order) or stored in the ME (in priority order).

The following are an example list of NAS messages (and not limited to) REGISTRATION REQUEST message; ATTACH REQUEST message; ATTACH ACCEPT message; ATTACH REJECT message; Tracking Area UPDATE Request message; TRACKING AREA UPDATE ACCEPT message; Tracking AREA UPDATE REJECT message; DETACH REQUEST message; DETACH ACCEPT message; DETACH REJECT message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; REGISTRATION ACCEPT; DEREGISTRATION ACCEPT; SERVICE REJECT; SERVICE ACCEPT; UE CONFIGURATION UPDATE command; UE PARAMETERS UPDATE command; and so on.

The term 5GMM sublayer states in the disclosure are at least one of the below:
1) 5GMM-NULL
2) 5GMM-DEREGISTERED
a) 5GMM-DEREGISTERED.NORMAL-SERVICE
b) 5GMM-DEREGISTERED.LIMITED-SERVICE
c) 5GMM-DEREGISTERED.ATTEMPTING-REGISTRATION
d) 5GMM-DEREGISTERED.PLMN-SEARCH
e) 5GMM-DEREGISTERED.NO-SUPI
f) 5GMM-DEREGISTERED.NO-CELL-AVAILABLE
g) 5GMM-DEREGISTERED.eCALL-INACTIVE
h) 5GMM-DEREGISTERED.INITIAL-REGISTRATION-NEEDED
3) 5GMM-REGISTERED-INITIATED
4) 5GMM-REGISTERED
a) 5GMM-REGISTERED.NORMAL-SERVICE
b) 5GMM-REGISTERED.NON-ALLOWED-SERVICE
c) 5GMM-REGISTERED.ATTEMPTING-REGISTRATION-UPDATE
d) 5GMM-REGISTERED.LIMITED-SERVICE
e) 5GMM-REGISTERED.PLMN-SEARCH
f) 5GMM-REGISTERED.NO-CELL-AVAILABLE
g) 5GMM-REGISTERED.UPDATE-NEEDED
5) 5GMM-DEREGISTERED-INITIATED
6) 5GMM-SERVICE-REQUEST-INITIATED

In the disclosure, the term EMM sublayer states are at least one of the below:
1) EMM-NULL
2) EMM-DEREGISTERED
a) EMM-DEREGISTERED.NORMAL-SERVICE
b) EMM-DEREGISTERED.LIMITED-SERVICE
c) EMM-DEREGISTERED.ATTEMPTING-TO-ATTACH
d) EMM-DEREGISTERED.PLMN-SEARCH
e) EMM-DEREGISTERED.NO-IMSI
f) EMM-DEREGISTERED.ATTACH-NEEDED
g) EMM-DEREGISTERED.NO-CELL-AVAILABLE
h) EMM-DEREGISTERED.eCALL-INACTIVE
3) EMM-REGISTERED-INITIATED
4) EMM-REGISTERED
a) EMM-REGISTERED.NORMAL-SERVICE
b) EMM-REGISTERED.ATTEMPTING-TO-UPDATE
c) EMM-REGISTERED.LIMITED-SERVICE
d) EMM-REGISTERED.PLMN-SEARCH
e) EMM-REGISTERED.UPDATE-NEEDED
f) EMM-REGISTERED.NO-CELL-AVAILABLE
g) EMM-REGISTERED.ATTEMPTING-TO-UPDATE-MM
h) EMM-REGISTERED.IMSI-DETACH-INITIATED
5) EMM-DEREGISTERED-INITIATED
6) EMM-TRACKING-AREA-UPDATING-INITIATED
7) EMM-SERVICE-REQUEST-INITIATED

The term RAT in this disclosure can be one of the following: NG-RAN, 5G, 4G, 3G, 2G, EPS, 5GS, NR (NR in unlicensed bands), NR (LEO) satellite access, NR (MEO) satellite access, NR (GEO) satellite access, NR (OTHERSAT) satellite access, NR RedCap, E-UTRA, E-UTRA in unlicensed bands, NB-IoT, WB-IoT, LTE-M, and so on.

5GS registration types can be, but not limited to, initial registration, mobility registration updating, periodic registration updating, emergency registration, SNPN onboarding registration, disaster roaming initial registration; disaster roaming mobility registration updating, and so on.

Not setting the registration type to disaster roaming initial registration or disaster roaming mobility registration updating may refer to 5GS registration type is set to value other than “disaster roaming initial registration” or ““disaster roaming mobility registration updating” at least one of initial registration, mobility registration updating, periodic registration updating, emergency registration, SNPN onboarding registration, and so on.

PLMN selection as per 23.122 without RPLMN: The MS selects and attempts registration on any PLMN/access technology combinations, if available and allowable, in the following order:
a. either the HPLMN (if the EHPLMN list is not present or is empty) or the highest priority EHPLMN that is available (if the EHPLMN list is present);
b. each PLMN/access technology combination in the “User Controlled PLMN Selector with Access Technology” data file in the SIM (in priority order);
c. each PLMN/access technology combination in the “Operator Controlled PLMN Selector with Access Technology” data file in the SIM (in priority order) or stored in the ME (in priority order);
d. other PLMN/access technology combinations with received high quality signal in random order; and
e. other PLMN/access technology combinations in order of decreasing signal quality.

PLMN selection as per 23.122 with RPLMN: The MS selects and attempts registration on any PLMN/access technology combinations, if available and allowable, in the following order:
a. either the RPLMN or the Last registered PLMN;
b. either the HPLMN (if the EHPLMN list is not present or is empty) or the highest priority EHPLMN that is available (if the EHPLMN list is present);
c. each PLMN/access technology combination in the “User Controlled PLMN Selector with Access Technology” data file in the SIM (in priority order);
d. each PLMN/access technology combination in the “Operator Controlled PLMN Selector with Access Technology” data file in the SIM (in priority order) or stored in the ME (in priority order);
e. other PLMN/access technology combinations with received high quality signal in random order; and
f. other PLMN/access technology combinations in order of decreasing signal quality.

For a 5G system with satellite access, the 5G system shall support service continuity between NR terrestrial access network and NR satellite access networks owned by the same operator or owned by 2 different operators having an agreement. The NTN and TN could either operate in two different frequency bands (e.g. FR1 vs FR2), or in same frequency band (e.g. FR1 or FR2). The Satellite System or Satellite Access as used or defined in the disclosure is applicable for both 5G system with satellite access and/or 4G system with satellite access or any RAT with satellite access. The terms Satellite 3GPP access, Satellite access, Satellite Access Network, NR Satellite Access Network, Satellite NG-RAN Access Technology and NR Satellite access have been interchangeably used and have the same meaning.

The methods, issues or example embodiments disclosed herein may be explained using NR satellite access or Satellite NG-RAN Access Technology as an example and is not restricted or limited to NR Satellite access only. However, the disclosure is also applicable for Satellite E-UTRAN access Technology, NB (Narrow Band)-S1 mode or WB (Wide Band)-S1 mode via satellite E-UTRAN access and/or NB-IoT (NarrowBand Internet Of Things) or WB-IoT (WideBand Internet Of Things) Satellite Access/Architecture.

The disclosures for NR (5GC) are also applicable to legacy RATs like E-UTRA/LTE, the corresponding CN entities needs to be replaced by LTE entities (for e.g. AMF with MME/AMF, g-nodeB with e-nodeB, UDM with HSS etc.). But principles of the solution remains same.

An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; DEREGISTRATION ACCEPT; SERVICE REJECT; SERVICE ACCEPT, and so on.

The Network used in is the disclosure may be explained using any 5G Core Network Function for e.g. AMF. However, the network could be any 5G/EUTRAN Core Network Entities like AMF/SMF/MME/AMF/UPF or the Network could be any 5G/EUTRAN RAN Entity like eNodeB (eNB) or gNodeB (gNB) or NG-RAN etc.

The messages in the disclosure are shown as an example. The messages could be any signalling messages between UE and the Network Functions/Entities or between different Network functions/entities.

The term area/location/geographical area in the disclosure may refer to any of cell/cell ID, TAC/TAI, PLMN, MCC/MNC, Latitude/longitude, CAG cell or any geographical location/coordinate.

The methods, issues or embodiments disclosed herein may be explained using NR access or NG-RAN Access Technology as an example and is not restricted or limited to NR access only. However, the disclosure is also applicable for E-UTRAN access Technology, NB (Narrow Band)-S1 mode or WB (Wide Band)-S1 mode via E-UTRAN access and/or NB-IoT (NarrowBand Internet Of Things) or WB-IoT (WideBand Internet Of Things) Access/Architecture.

The disclosures for NR (5GC) are also applicable to legacy RATs like E-UTRA/LTE, the corresponding CN entities needs to be replaced by LTE entities for e.g. AMF with MME/AMF, g-nodeB with e-nodeB, UDM with HSS etc. But principles of the solution remains same.

The Network used in the disclosure may be explained using any 5G Core Network Function (for e.g. AMF). However, the network could be any 5G/EUTRAN Core Network Entities like AMF/SMF/MME/AMF/UPF or the Network could be any 5G/EUTRAN RAN Entity like eNodeB (eNB) or gNodeB (gNB) or NG-RAN etc.

The messages used or indicated in the disclosure are shown as an example. The messages could be any signalling messages between UE and the Network Functions/Entities or between different Network functions/entities.

The terms camp and register are used interchangeably and have the same meaning.

The terms wait timer, DisCo wait timer, Discontinuous Coverage wait timer, Random timer, Random wait timer, DCW Timer are all used interchangeably and have the same meaning.

The terms wait range, Disco Wait Range, Discontinuous Coverage Wait Range, DCW Range are all used interchangeably and have the same meaning.

The term area as used in the disclosure may refer to any of cell/cell ID, TAC/TAI, PLMN, MCC/MNC, Latitude/longitude, any CAG/CAG identifier or any geographical location/coordinate.

For the list of possible NAS messages, please refer to 3GPP TS 24.501 or 3GPP TS 24.301, for list of AS messages please refer to 3GPP TS 38.331 or 3GPP TS 36.331

The cause names in the disclosure are for illustration purposes and it can have any name. The non access stratum (NAS) messages and access stratum (AS) messages described in is the disclosure are for illustration purpose it can be any NAS or AS messages as per defined protocol between UE and AMF/MME/AMF or UE and gNB (NG-RAN/any RAN node)/eNB.

In the disclosure, the term Satellite is used interchangeably with 5G or 4G system with satellite access and is used to represent any Satellite(s) or constellation of Satellites(s) or any aerial body/satellite in any of the Satellite orbits (for ex-LEO/MEO/GEO/HEO etc) or any 5G system with Satellite Access or 4G System with Satellite Access or any RAN Entity or Core Network Entity or any Network Function(s) associated with the Satellite Access/RAT/PLMN/Network.

The terms MME/AMF-Onboard and MME/AMF-lighter are used interchangeably in the disclosure and have the same meaning.

The terms SAT and Satellite are used interchangeably in the disclosure and have the same meaning.

Serving satellite: A satellite providing the satellite access to a UE. In the case of NGSO (Non-Geostationary Satellite Orbit), the serving satellite is always changing due to the nature of the constellation.

Store & Forward Satellite operation: In the context of this study, it is an operation mode of a 5G system with satellite-access where the 5G system can provide some level of service (in storing and forwarding the data) when satellite connectivity is intermittently/temporarily unavailable, e.g. to provide communication service for UEs under satellite coverage without a simultaneous active feeder link connection to the ground segment.

UE-Satellite-UE Communication: For the 5G system with satellite access, it refers to the communication between UEs under the coverage of one or more serving satellites, using satellite access without going through the ground segment.

The MME/AMF-ground acts like an anchor/database and if there is any change in the UE context or UE context is created then MME/AMF-onground will notify the updated UE context to all the MME/AMF(s)-onboard whenever the feeder link is available. e.g., whenever MME/AMF-ground and MME/AMF-onboard can communicate. The UE Context used in the disclosure, can refer to the UE Context stored in the MME/AMF as shown in the disclosure or as defined in 3GPP TS 23.401 (for LTE) or 23.502 (for NR). The Satellite System or Satellite Access as used or defined in the disclosure is applicable for both 5G system with satellite access and/or 4G system with satellite access or any RAT with satellite access. The methods, issues or solutions disclosed herein are explained using E-UTRAN/LTE satellite access or Satellite E-UTRAN Access Technology as an example and is not restricted or limited to E-UTRAN/LTE Satellite access only. However, the disclosure is also applicable for Satellite NG-RAN access Technology, NB (Narrow Band)-S1 mode or WB (Wide Band)-S1 mode via satellite E-UTRAN access and/or NB-IoT (NarrowBand Internet Of Things) or WB-IoT (WideBand Internet Of Things) Satellite Access/Architecture. The solutions which are defined for LTE (EPS) are also applicable to Other RATs like NR/NG-RAN/5G, the corresponding CN entities needs to be replaced by NR entities for e.g. MME with AMF, e-nodeB with g-nodeB, HSS with UDM etc. But principles of the solution remains same. For ex-MME (on Board) can be replaced with AMF (On Board), similarly MME (on ground) can be replaced with AMF (on ground) etc. The Network used in the disclosure is explained using any 4G/LTE Core Network Function for e.g. MME. However, the network could be any 5G/EUTRAN Core Network Entities like AMF/SMF/MME/AMF/UPF or the Network could be any 5G/EUTRAN RAN Entity like eNodeB (eNB) or gNodeB (gNB) or NG-RAN etc.

The MME functions include: NAS signalling; NAS signalling security; Inter CN node signalling for mobility between 3GPP access networks (terminating S3); UE Reachability in ECM-IDLE state (including control, execution of paging retransmission and optionally Paging Policy Differentiation); Tracking Area list management; Mapping from UE location (e.g. TAI) to time zone, and signalling a UE time zone change associated with mobility, PDN GW and Serving GW selection; MME selection for handovers with MME change; SGSN selection for handovers to 2G or 3G 3GPP access networks; Roaming (S6a towards home HSS); Authentication, Authorization; Bearer management functions including dedicated bearer establishment; Lawful Interception of signalling traffic; Warning message transfer function (including selection of appropriate eNodeB); UE Reachability procedures; Support Relaying function (RN Attach/Detach); Change of UE presence in Presence Reporting Area reporting upon PCC request, in the case of Change of UE presence in Presence Reporting Area reporting, management of Core Network pre-configured Presence Reporting Areas, for the Control Plane CIoT EPS Optimisation:
a) transport of user data (IP, Non-IP and Ethernet));
b) local Mobility Anchor point;
c) header compression (for IP user data);
d) ciphering and integrity protection of user data;
e) Lawful Interception of user traffic not transported via the Serving GW (e.g. traffic using T6a).

The Serving GW and the MME may be implemented in one physical node or separated physical nodes. For CIoT EPS Optimisation, the Serving GW and the MME can be implemented in one physical node (e.g. C-SGN) or separated physical nodes. The C-SGN can also encompass the PDN GW function.

The MME shall signal a change in the UE Time Zone only in the case of mobility and in the case of UE triggered Service Request, PDN Disconnection and UE Detach. If the MME cannot determine whether the UE Time Zone has changed (for example, the UE Time Zone is not sent by the old MME during MME relocation), the MME should not signal a change in UE Time Zone. A change in the UE Time Zone (caused by a regulatory mandated time change (e.g. daylight saving time or summer time change)) shall not trigger the MME to initiate signalling procedures due to the actual change. Instead, the MME shall wait for the UE's next mobility event or Service Request procedure and then use these procedures to update the UE Time Zone information in the PDN GW.

The Access and Mobility Management function (AMF) includes the following functionality. Some or all of the AMF functionalities may be supported in a single instance of an AMF: Termination of RAN CP interface (N2), Termination of NAS (N1), NAS ciphering and integrity protection, Registration management, Connection management, Reachability management, Mobility Management, Lawful intercept (for AMF events and interface to LI System), Provide transport for SM messages between UE and SMF, Transparent proxy for routing SM messages, Access Authentication, Access Authorization, Provide transport for SMS messages between UE and SMSF, Security Anchor Functionality (SEAF) as specified in TS 33.501, Location Services management for regulatory services, Provide transport for Location Services messages between UE and LMF as well as between RAN and LMF, EPS Bearer ID allocation for interworking with EPS, UE mobility event notification, S-NSSAIs per TA mapping notification, Support for Control Plane CIoT 5GS Optimisation, Support for User Plane CIoT 5GS Optimisation, Support for restriction of use of Enhanced Coverage, Provisioning of external parameters (Expected UE Behaviour parameters or Network Configuration parameters), Support for Network Slice-Specific Authentication and Authorization, Support for charging, Controlling the 5G access stratum-based time distribution based on UE's subscription data, Controlling the gNB's time synchronization status reporting and subscription, and so on.

Regardless of the number of Network functions, there is only one NAS interface instance per access network between the UE and the CN, terminated at one of the Network functions that implements at least NAS security and Mobility Management.

In addition to the functionalities of the AMF described above, the AMF may include the following functionality to support non-3GPP access networks:
a. Support of N2 interface with N3IWF/TNGF. Over this interface, some information (e.g. 3GPP Cell Identification) and procedures (e.g. Handover related) defined over 3GPP access may not apply, and non-3GPP access specific information may be applied that do not apply to 3GPP accesses.
b. Support of NAS signalling with a UE over N3IWF/TNGF. Some procedures supported by NAS signalling over 3GPP access may be not applicable to untrusted non-3GPP (e.g. Paging) access.
c. Support of authentication of UEs connected over N3IWF/TNGF.
d. Management of mobility, authentication, and separate security context state(s) of a UE connected via a non-3GPP access or connected via a 3GPP access and a non-3GPP access simultaneously.
e. Support a co-ordinated RM management context valid over a 3GPP access and a Non 3GPP access.
f. Support dedicated CM management contexts for the UE for connectivity over non-3GPP access.
g. Determine whether the serving N3IWF/TNGF is appropriate based on the slices supported by the N3IWFs/TNGFs.

Not all of the functionalities are required to be supported in an instance of a Network Slice.

In addition to the functionalities of the AMF described above, the AMF may include policy related functionalities as described in clause 6.2.8 of TS 23.503. The AMF uses the N14 interface for AMF re-allocation and AMF to AMF information transfer. This interface may be either intra-PLMN or inter-PLMN (e.g. in the case of inter-PLMN mobility). In addition to the functionality of the AMF described above, the AMF may include the following functionality to support monitoring in roaming scenarios:
a. Normalization of reports according to roaming agreements between VPLMN and HPLMN (e.g. change the location granularity in a report from cell level to a level that is appropriate for the HPLMN); and
b. Generation of charging/accounting information for Monitoring Event Reports that are sent to the HPLMN.

In addition to the functionality of the AMF described above, the AMF may provide support for Network Slice restriction and Network Slice instance restriction based on NWDAF analytics. In addition to the functionalities of the AMF described above, the AMF may provide support for the Disaster Roaming. In addition to the functionalities of the AMF described above, the AMF may also include following functionalities to support Network Slice Admission Control:
a. Support of NSAC for maximum number of UEs.

In addition to the functionality of the AMF described above, the AMF may include the following functionality to support SNPNs:
a. Support for Onboarding of UEs for SNPNs.

In addition to the functionalities of the AMF described above, the AMF may also include following functionalities to support satellite backhaul:
a. Support for reporting satellite backhaul category (e.g., GEO, MEO, LEO or OTHERSAT) and its modification based on AMF local configuration to SMF.

In addition to the functionalities of the AMF described above, the AMF may provide support for Network Slice instance change for PDU sessions.

In addition to the functionalities of the AMF described above, the AMF may also support functionalities for Partial Network Slice support in a Registration Area.

In addition to the functionalities of the AMF described above, the AMF may also include functionalities to support NS-AoS not matching deployed Tracking Areas.

In addition to the functionalities of the AMF described above, the AMF may also include functionalities to support Network Slice Replacement.

The MME shall signal a change in UE Time Zone only in the case of mobility and in the case of UE triggered Service Request, PDN Disconnection and UE Detach. If the MME cannot determine whether the UE Time Zone has changed (e.g. the UE Time Zone is not sent by the old MME during MME relocation), the MME should not signal a change in UE Time Zone. A change in UE Time Zone caused by a regulatory mandated time change (e.g. daylight saving time or summer time change) shall not trigger the MME to initiate signalling procedures due to the actual change. Instead, the MME shall wait for the UE's next mobility event or Service Request procedure and then use these procedures to update the UE Time Zone information in the PDN GW.

FIG. 3 is a block diagram illustrating an example architecture for enabling operation of cellular communication networks with satellite access according to various embodiments. The UE (102) can register with the MME/AMF (304), when both service link and feeder link are available. The MME/AMF has configured a Periodic TAU (PTAU) timer such that the UE (102) will always remain registered with the network. The MME/AMF and other Core Network (CN) functions are on ground. When the UE (102) does not see a signal (service link), then the UE (102) is in a discontinuous coverage area, but its registration status is maintained. The MME/AMF should provide a PTAU considering both of this parameters (e.g., considering both feeder link and service link availability). Once the UE (102) departs from its location, it will not have connectivity to ground station (or any Network Functions/Entities on ground). From here/this time onwards, the UE (102) at any point of time either have a service link (from the UE perspective) or a feeder link (from CN perspective) from a given LEO satellite or any NGSO Satellite or any satellite; but not at the same time. The Store and Forward (S/F) functional is required from state “2”, optionally till the UE (102) is back to the coverage/area where both the service link and the feeder link is available. The first satellite contacting the UE (102) with the service link will be the first satellite contacting the ground MME/AMF (304) and in a circular mechanism. For more than one satellite, at least the AUSF and the UDM are not over the satellite. The PTAU timer is not related to going to the connected mode anymore, because the UE (102) can get into connected mode, but still it will not restart the timer as ground MME/AMF (304) is not yet synced. When a message is received from the ground MME/AMF (304), the UE (102) can restart the timer, the MME/AMF should consider the delay (due to deliver)+PTAU timer as the value of the timer.

Synchronizing UE contexts between the satellites: The term ACK (or acknowledgement) in the disclosure should be treated as one of the NAS/AS messages described in TS 24.501/24.301 or 36.304/38.304. For example, when the UE (102) sends an Attach/TAU request message, the MME-onboard the satellite may send the UE (102) with attach accept or TAU accept with the minimal context MME/AMF is holding. Later, the MME/AMF-onboard (306) will deliver the NAS message to the ground MME/AMF (304). The ground MME/AMF (304) will start executing the procedure and once the procedure is executed, the MME/AMF will provide the attach accept/tau accept/registration accept message (which will have all the contents required by the UE to create the UE context).

In an embodiment, the term satellite is used which actually represents at least one of the NF or gNB which is onboard from the 3GPP perspective. Thus, for example, when the term indicates that the UE (102) sends data to the satellite, it implies that data is sent to one of NFs or gNB (in general node of 3GPP system), which is onboard of the satellite. Similarly, when the satellite sends the data, one of NFs or gNB (in general node of 3GPP system) which is onboard of the satellite sends the data to UE (102) or the NF/3GPP node at the ground.

The MME/AMF(s) (e.g., the MME/AMF (on ground)) (304) may be pre-configured or may have an information as to which satellites (e.g., which MME/AMF(s)-OnBoard) (304) will be serving the UE(s) (102) in the given location (for example, with the identifier like satellite ID/MME ID or N2-ID or S1-AP ID etc.). The MME/AMF (on ground) (304) may share/indicate the UE context (for example, required/full UE Context or Lighter UE Context) to the Satellites/MME/AMF(s)-onBoard which may serve the UE (102), optionally at any time or any later time at the present/extrapolated UE location (e.g., for example, based on UE mobility/trajectory pattern). If there is a change in the UE context (for example, due to registration procedure triggered by the UE (102) on the same onboard MME/AMF/satellite or different on-board MME/AMF or satellite) or if the MME/AMF (on ground) determines that there is a change in the stored UE Context, then the MME/AMF (on ground) shall share the updated UE context (for example, required/full UE Context or Lighter UE Context), optionally if the feeder link is available, to the Satellites/MME/AMF(s)-onBoard which may serve the UE, optionally at any time or any later time at the present/extrapolated UE location (e.g., for ex-based on UE mobility/trajectory pattern).

In an embodiment herein, the MME/AMF (on ground) (304) shall share the updated UE context (for example, required/full UE Context or Lighter UE Context), optionally if the feeder link is available, to the Satellites/MME/AMF(s)-onBoard (306), which may have the Old UE Context and which may serve the UE (102), optionally at any time or any later time at the present/extrapolated UE location (e.g., for ex-based on UE mobility/trajectory pattern). In an embodiment herein, the MME/AMF (on ground) (304) shall share the updated UE context (for example, required/full or UE Lighter Context UE Context) to the Satellites/MME/AMF(s)-onBoard (306), which may serve the UE (102), optionally at any time or any later time at the present/extrapolated UE location (e.g., for ex-based on UE mobility/trajectory pattern), at a later point of time, when the feeder link is available. The Satellites/MME/AMF(s)-OnBoard may store two UE Context(s) (for example, the old UE Context and the updated UE Context) for the same UE(s) for certain time duration, optionally till the UE Context is fully synchronised between the UE(s), and/or serving MME/AMF(s) (on ground) and/or the serving satellite/MME/AMF-OnBoard and/or all the satellites/MME/AMF(s)-OnBoard, which may serve the UE, optionally at any point of time at the present/extrapolated UE location. In general, the MME-onboard/AMF-onboard and the MME-onground/AMF-onground etc will share the context with each other if there is a change and all the NFs (which are on the satellite and on the ground) are expected to have the same context, so that they can serve the UE at the any time.

A network function instance can be deployed such that several network function instances are present within an NF Set to provide distribution, redundancy and scalability together as a Set of NF instances. The same is also supported for NF Services. This can be achieved when the equivalent NFs and NF Services share the same context data or by Network Function/NF Service Context Transfer procedures. Equivalent Control Plane NFs may be grouped into NF Sets; for example, several SMF/MME/AMF instances are grouped into an MME/AMF/SMF Set. The NFs within a NF Set are interchangeable because they share the same context data, and may be deployed in different locations; for example, different data centres, on the satellite and on the ground station etc.

In the disclosure, the MME/AMF on-board and the MME/AMF on the ground is used as an example, but this same concept can be applied for any of the network functions (NFs). The list of NFs (for example, SMF/PCF/UDM/AUSF/MME/P-GW/S-GW/HSS/NEF/SCEF) are described in TS 23.501. A Control Plane NF comprises of one or multiple NF Services. Within a NF, a NF service may have multiple instances. These multiple NF Service instances can be grouped into one or more NF Service Sets, if they are interchangeable with each other because they share the same context data. The ground NF (for example, MME/AMF) also can be treated as a UDSF function with whom the UE context data is synchronized by all the NFs onboard the satellite.

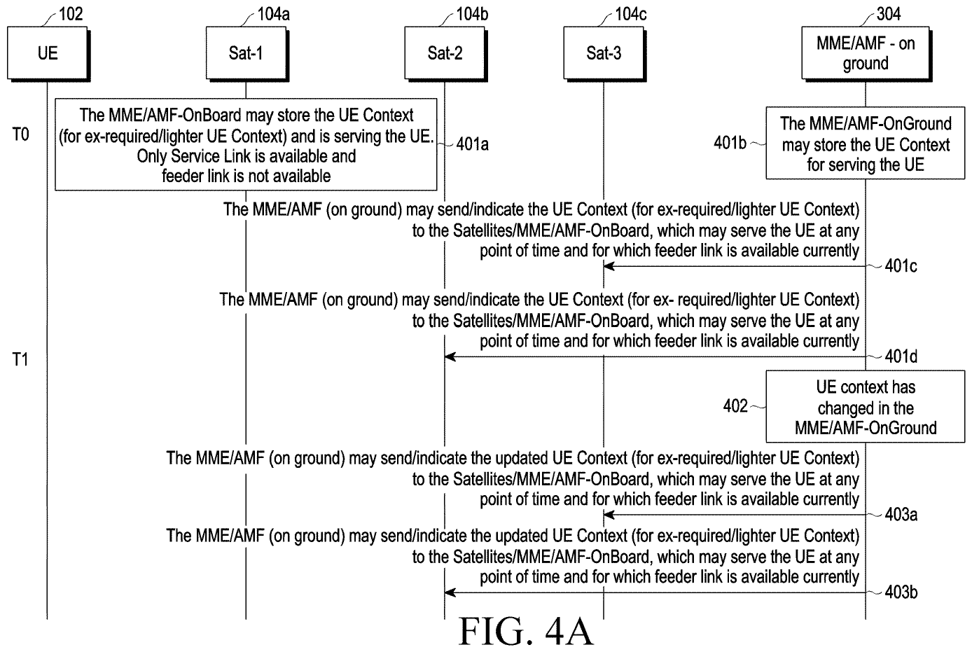

FIG. 4A and FIG. 4B are signal flow diagrams illustrating example processes of transferring the UE context according to various embodiments. In step 401a, at Time T0, the MME/AMF-OnBoard (306) may store the UE Context (for ex-required/lighter UE Context) and is serving the UE (e.g. the UE is registered with the network and network is maintaining the UE context). Only Service Link is available and feeder link is not available. In step 401b, the MME/AMF-OnGround (304) may store the UE Context for serving the UE (102). In steps 401c and 401 d, the MME/AMF (on ground) (304) may send/indicate the UE Context (for ex-required/lighter UE Context) to the Satellites/MME/AMF-OnBoard (306), which may serve the UE (102) at any point of time and for which feeder link is available currently (for example, Sat-2 and Sat-3). In step 402, at Time T1, the UE context has changed to the MME/AMF-OnGround (304). In steps 403a and 403b, the MME/AMF (on ground) (304) may send/indicate the updated UE Context (for example, required/lighter UE Context) to the Satellites/MME/AMF-OnBoard (306), which may serve the UE (102) at any point of time and for which feeder link is available currently (for example, Sat-2 and Sat-3).

In steps 403c and 403d, the MME/AMF(s)-OnBoard (for example, MME/AMF-OnBoard (306) of Satellites Sat-2 and Sat-3) may store the new UE Context and optionally may store the Old UE Context, optionally for serving the UE(s) (102) whenever the service link is available. In step 404, at Time T2, the feeder link is available between Sat-1 and MME/AMF-OnGround (304). In step 404a, the MME/AMF (on ground) (304) may send/indicate the updated UE Context (for example, required/lighter UE Context) to the Satellites/MME/AMF-OnBoard, which may serve the UE (102) at any point of time (for example, based on UE location) and for which feeder link is available currently (for example, Sat-1). In step 404b, the MME/AMF(s)-OnBoard (306) (for example, MME/AMF-OnBoard (306) of Satellite Sat-1) may store the new UE Context and optionally may store the Old UE Context, optionally for serving the UE(s) whenever the service link is available.

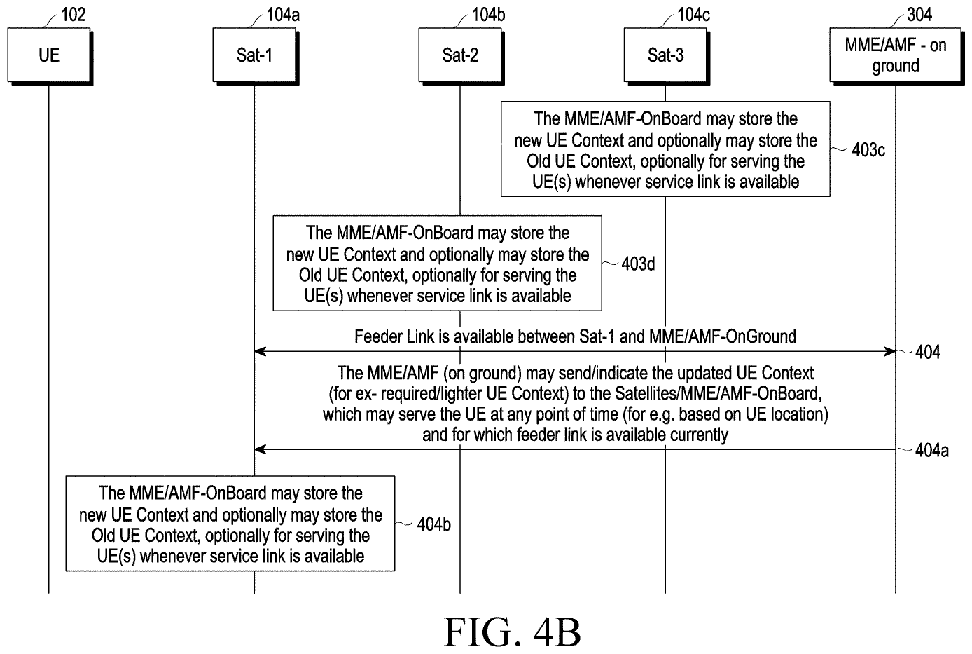

FIG. 5 is a block diagram illustrating an example configuration of the MME-ground (304), according to various embodiments. In an embodiment, the MME-ground (304) includes a processor (e.g., including processing circuitry) (510), a communicator (e.g., including communication circuitry) (520), a memory (530), and a UE context controller (e.g., including circuitry) (540). The processor (510) is coupled with the communicator (520), the memory (530), and the UE context controller (540).

In an embodiment, the MME-onboard (306) acts as a slave node to the MME-ground (304), where the MME-ground (304) have an address of a subset of the at least one MME-onboard (306). The at least one MME-onboard (306) serves the UE (102) based on a location of the UE (102).

The MME-ground (304) is an anchor node situated in the ground network (106) which has the UE context, where the MME-ground (304) synchronizes the UE context with the at least one MME-onboard (306).

The MME-ground (304) is locally configured with an information or is configured by at least one of: an O&M entity and an AF entity (not shown) through a SCEF path (not shown).

The UE context controller (540) may include various circuitry and maintains the UE context in response to the UE registering with the network entity (e.g., eNB, gNB or the like). Further, the UE context controller (540) identifies the at least one MME-onboard (306) in which the satellite (104) serves the UE (102). The at least one MME-onboard (306) is identified based on a location of the UE (102). Further, the UE context controller (540) shares the UE context stored at the MME-ground (304) with the at least one identified MME-onboard (306). The UE context, stored at the MME-ground (304), is shared in response to determining that the feeder link is established between the MME-ground (304) and the at least one MME-onboard (306).

Further, the UE context controller (540) manages the synchronized UE context on the at least one identified MME-onboard (306).

In an embodiment, the UE context controller (540) detects that the UE context has changed from a first UE context to a second UE context. Further, the UE context controller (540) identifies the at least one MME-onboard (306) in which the satellite serves the UE based on the detection. Further, the UE context controller (540) shares the second UE context stored at the MME-ground (304) with the at least one identified MME-onboard.

In an embodiment, the UE context controller (540) detects the change in the UE serving area. Further, the UE context controller (540) identifies the at least one MME-onboard (306) in which the satellite serves the UE based on the detection. Further, the UE context controller (540) shares the UE context stored at the MME-ground (304) with the at least one identified MME-onboard (306).

In an embodiment, the UE context controller (540) detects the change in the UE serving area. Further, the UE context controller (540) identifies the at least one MME-onboard (306) in which the satellite (104) does not serve the UE (102) based on the detection. Further, the UE context controller (540) deletes the UE context shared at the at least one identified MME-onboard.

The UE context is created or changed in the at least one MME-onboard (306), where the UE context is synchronized with the at least one MME-onboard, when the at least one MME-onboard (306) connects with a ground network.

Further, the UE context controller (540) supports the store and forward service in the satellite communication based on the synchronized UE context.

The UE context controller (540) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (510) may include various processing circuitry including one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (510) may include multiple cores and is configured to execute the instructions stored in the memory (530).

Further, the processor (510) is configured to execute instructions stored in the memory (530) and to perform various processes. The communicator (520) is configured for communicating internally between internal hardware components and with external devices via one or more networks. The memory (530) also stores instructions to be executed by the processor (510). The memory (530) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (530) may, in some examples, be considered a non-transitory storage medium. The “non-transitory” storage medium is not embodied in a carrier wave or a propagated signal. However, the term “non-transitory” should not be interpreted that the memory (530) is non-movable. In certain examples, a non-transitory storage medium may store data that can, over time, change (e.g., in Random Access Memory (RAM) or cache). Thus, the processor (510) may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Although FIG. 5 shows various hardware components of the MME-ground (304) but it is to be understood that various embodiments are not limited thereto. In various embodiments, the MME-ground (304) may include less or more number of components. Further, the labels or names of the components are used only for illustrative purposes and does not limit the scope of the disclosure. One or more components can be combined together to perform the same or substantially similar function in the MME-ground (304).

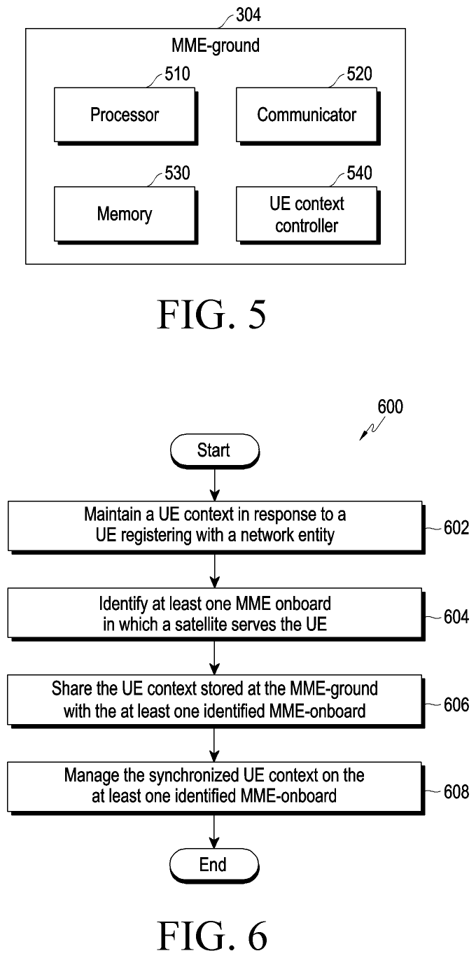

FIG. 6 is a flowchart (800) illustrating an example method for handling the UE context for satellite communication, according to various embodiments. The operations (602-608) are handled by the UE context controller (540).

At 602, the method includes maintaining the UE context in response to the UE registering with the network entity. At 604, the method includes identifying the at least one MME-onboard (306) in which the satellite (104) serves the UE (102). The identified at least one MME-onboard (306) may be in a corresponding satellite having possibility ot serve the UE (102) At 606, the method includes sharing the UE context stored at the MME-ground (304) with the at least one identified MME-onboard. At 608, the method may further include managing the synchronized UE context on the at least one identified MME-onboard (306).

The disclosed methods allow the UE (102) to get seamless service from different satellites (or MMEs) in the given area. This results in improving the user experience.

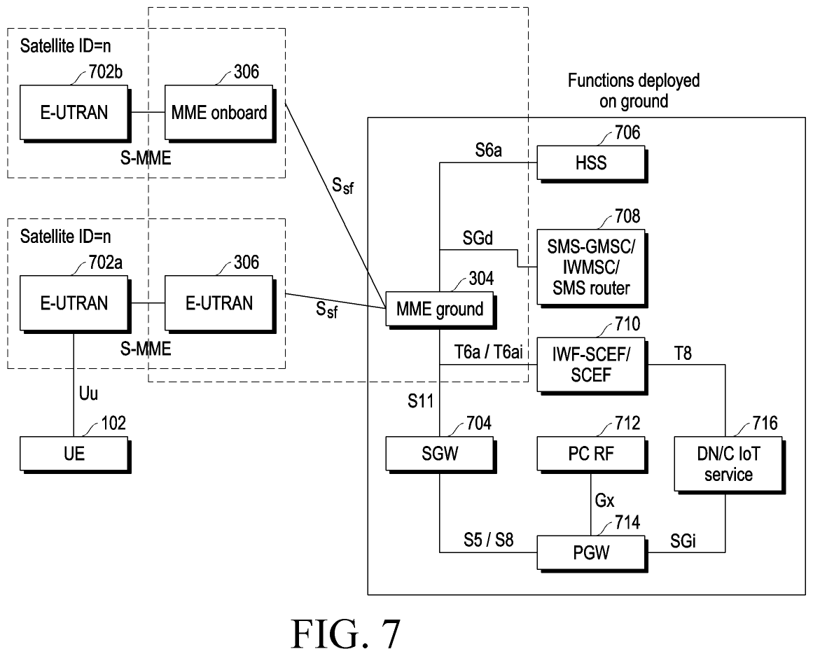

FIG. 7 is a diagram illustrating an example 4G satellite architecture for distributed UE context management, according to various embodiments. The MME ground (304) is coupled with the MME onboard (306), where the MME onboard (306) is communicated with E-UTRAN(s) (702a, 702b) or NR or in general RAN network. The MME ground (304) communicates with a SGW (704), a HSS (706), a SMS-GMSC/IWMS C/SMS router (708), IWF-SCEF/SCEF (710), a PC RF (712), a PGW (714) and a DN/CIoT service (716), in general any core network nodes at the ground network.

The 4G satellite architecture (e.g., split MME architecture) between an onboard satellite and a ground satellite is introduced to support distributed UE context storage so that the store and forward service can be supported using the satellite communication. The MME-ground (304) acts the anchor node and the MME-onboard (306) acts as a slave nodes to the MME-ground (304). The UE context is distributed across all the MME(s). The UE (102) can access any of the MMEs without knowing which MME the UE (102) is accessing to. There can be many MME-onboards of different satellites. The MME-ground (304) have the address of subset of the MME-onboards (306) which will serve the UE (102) based on the location of serving the UE (102). If there is any change in the UE context, the MME-ground (304) is responsible to identify it and sync the UE context on all the MME-onboard (306) which are serving the UE in a given location. If a particular MME-onboard (306) will not serve the UE (102) (for e.g. due to new location of the UE) then the MME-ground (304) should remove the UE context from that particular MME-onboard. The MME-ground (304) is locally configured with an information or is configured by at least one of: an O&M entity and an AF entity (not shown) through a SCEF path (not shown).

The MME-ground (304) maintains the UE context in response to the UE registering with the network entity (e.g., eNB, gNB or the like). Further, the MME-ground (304) identifies the at least one MME-onboard (306) in which the satellite (104) serves the UE (102). The at least one MME-onboard (306) is identified based on a location of the UE (102). Further, the MME-ground (304) shares the UE context stored at the MME-ground (304) with the at least one identified MME-onboard (306). The UE context, stored at the MME-ground (304), is shared in response to determining that the feeder link is established between the MME-ground (304) and the at least one MME-onboard (306).

Further, the MME-ground (304) manages the synchronized UE context on the at least one identified MME-onboard (306). In an embodiment, the MME-ground (304) detects that the UE context has changed from a first UE context to a second UE context. Further, the MME-ground (304) identifies the at least one MME-onboard (306) in which the satellite serves the UE based on the detection. Further, the MME-ground (304) shares the second UE context stored at the MME-ground (304) with the at least one identified MME-onboard.

In an embodiment, the MME-ground (304) detects the change in the UE serving area. Further, the MME-ground (304) identifies the at least one MME-onboard (306) in which the satellite serves the UE based on the detection. Further, the MME-ground (304) shares the UE context stored at the MME-ground (304) with the at least one identified MME-onboard (306).

In an embodiment, the MME-ground (304) detects the change in the UE serving area. Further, the MME-ground (304) identifies the at least one MME-onboard (306) in which the satellite (104) does not serve the UE (102) based on the detection. Further, the MME-ground (304) deletes the UE context shared at the at least one identified MME-onboard.

Further, the MME-ground (304) supports the store and forward service in the satellite communication based on the synchronized UE context.

The wireless network can be, for example, but not limited to a fourth generation (4G) network, a 5G network, a sixth generation (6G) network, ORAN or the like.

The UE (102) can be, for example, but not limited to a laptop, a desktop computer, a notebook, a Device-to-Device (D2D) device, a vehicle to everything (V2X) device, a smartphone, a foldable phone, a smart TV, a tablet, an immersive device, and an internet of things (IoT) device. The AMF entity has provided S-NSSAI1 into Partially Allowed NSSAI or this S-NSSAI1 is associated with NS-AoS.

Table 1 to Table 9 illustrate the UE context, wherein at least one of the parameters/fields is stored in the onboard/ground AMF/MME.

The example embodiments disclosed herein describes an architecture for cellular communication networks with satellite access. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the disclosure may be implemented on different hardware devices, e.g., using a plurality of CPUs.

The foregoing description of the specific embodiments will so fully reveal the general nature of the various embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the various embodiments herein have been described in terms of embodiments, those skilled in the art will recognize that the various embodiments herein can be practiced with modification within the scope of the various embodiments as described herein.

TABLE 1

| Field | Description |
|---|---|
| IMSI | IMSI (International Mobile Subscriber Identity) is the |
| | subscriber's permanent identity. |
| IMSI-unauthenticated-indicator | This is an IMSI indicator to show the IMSI is unauthenticated. |
| Alternative IMSI | The Alternative IMSI is derived from the Accepted IMSI |
| | Offset used for Paging Timing Collision Control. |
| RLOS-indicator | This is indication to show that the UE is RLOS attached. |
| MSISDN | The basic MSISDN of the UE. The presence is dictated by its |
| | storage in the HSS. |
| MM State | Mobility management state ECM-IDLE, ECM-CONNECTED, |
| | EMM-DEREGISTERED. |
| GUTI | Globally Unique Temporary identity. |
| ME Identity | Mobile Equipment identity - (e.g. IMEI/IMEISV) Software |
| | Version Number |
| Tracking Area List | Current Tracking area list |
| TAI of last TAU | TAI of the TA in which the last Tracking Area Update was |
| | initiated. |
| E-UTRAN Cell Global Identity | Last known E-UTRAN cell |
| E-UTRAN Cell Identity Age | Time elapsed since the last E-UTRAN Cell Global identity was |
| | acquired |
| PS Cell Global Identity | Last known Primary Cell of Secondary Cell Group |
| PS Cell Age | Time elapsed since the last Primary Cell of Secondary Cell |
| | Group Identity was acquired |
| CSG ID | Last known CSG ID when the UE was active |
| CSG membership | Last known CSG membership of the UE when the UE was |
| | active |
| Access mode | Access mode of last known ECGI when the UE was active |
| Authentication Vector | Temporary authentication and key agreement data that enables |
| | an MME to engage in AKA with a particular user. An EPS |
| | Authentication Vector consists of four elements: |
| | a) network challenge RAND, |
| | b) an expected response XRES, |
| | ¢) Key K_{ASME}, |
| | d) a network authentication token AUTN. |
| UE Radio Access Capability | UE radio access capabilities including WB-E-UTRAN |
| | capabilities but not NB-IoT capabilities. |
| UE Radio Capability lD | If RACS is supported, uniquely identifies a set of UE radio |
| | access capabilities |
| LTE-M Indication | indicates the UE is a LTE-M UE and the UE Radio Access |
| | Capability includes LTE Cat-M1 or LTE Cat-M1 and LTE |
| | Cat-M2. This is based on indication from the E-UTRAN |
| | provides. |
| NB-IoT specific UE Radio | NB-IoT specific UE radio access capabilities. |
| Access Capability | |
| MS Classmark 2 | GERAN/UTRAN CS domain core network classmark (used if |
| | the MS supports SRVCC to GERAN or UTRAN). |
| MS Classmark 3 | GERAN CS domain radio network classmark (used if the MS |
| | supports SRVCC to GERAN). |
| Supported Codecs | List of codecs supported in the CS domain (used if the MS |
| | supports SRVCC to GERAN or UTRAN). |
| UE Network Capability | UE network capabilities including security algorithms and |
| | other capabilities. |
| MS Network Capability | For a GERAN and/or UTRAN capable UE, this contains |
| | information needed by the SGSN. |
| UE Specific DRX Parameters | UE specific DRX parameters for A/Gb mode, Iu mode and |
| | WB-E-UTRAN S1-mode. |
| UE Specific DRX Parameter | UE Specific DRX Parameter for NB-IoT S1-mode. |
| for NB-loT | |
| Active Time value for PSM | UE specific Active Time value allocated by MME for power |
| | saving mode handling. |
| Extended idle mode DRX | Negotiated extended idle mode DRX parameters for S1-mode. |
| parameters | |
| RAT specific Subscribed | Indicates a Subscribed Paging Time Window value for the |
| Paging Time Window | associated RAT, NB-IoT, WB-E-UTRAN or both. |
| Selected NAS Algorithm | Selected NAS security algorithm |
| eKSI | Key Set identifier for the main key K_{ASME}. Also indicates |
| | whether the UE is using security keys derived from UTRAN or |
| | E-UTRAN security association. |
| K_{ASME} | Main key for E-UTRAN key hierarchy based on CK, IK and |
| | Serving network identity |
| NAS Keys and COUNT | K_{NASint}, K_{_{—}}_{NASenc}, and NAS COUNT parameter. |
| Selected CN operator id | Selected core network operator identity (to support network |
| | sharing as defined in TS 23.251 [24]). |
| Recovery | indicates if the HSS is performing database recovery. |

TABLE 2

| | |
|---|---|
| Access Restriction | The access restriction subscription information. For this purpose, |
| | WB-E-UTRAN and NB-IoT are separate RATs. in addition, it |
| | includes restriction information on the use of NR as secondary RAT |
| | for user plane connectivity, the use of Unlicensed Spectrum (in the |
| | form of LAA, or LWA/LWIP. or NR-U). |
| Communication | Indicates per UE the Communication Patterns and their |
| Patterns | corresponding validity times as specified in TS 23.682 [74]. The |
| | Communication Patterns are not provided to the SGSN. |
| ODB for PS parameters | Indicates that the status of the operator determined barring for |
| | packet oriented services. |
| APN-OI Replacement | Indicates the domain name to replace the APN-OI when |
| | constructing the PDN GW FQDN upon which to perform a DNS |
| | resolution. This replacement applies for all the APNs in the |
| | subscribers profile. See TS 23.003 [9] clause 9.1.2 for more |
| | information on the format of domain names that are allowed in this |
| | field. |
| MME IP address for | MME IP address for the S11 interface (used by S-GW) |
| S11 | |
| MME TEID for S11 | MME Tunnel Endpoint Identifier for S11 interface. |
| S-GW IP address for | S-GW IP address for the S11 and S4 interfaces |
| S11/S4 | |
| S-GW TEID for S11/S4 | S-GW Tunnel Endpoint Identifier for the S11 and S4 interfaces. |
| SGSN IP address for S3 | SGSN IP address for the S3 interface (used if ISR is activated for |
| | the GERAN and/or UTRAN capable UE) |
| SGSN TEID for S3 | SGSN Tunnel Endpoint Identifier for S3 interface (used if ISR is |
| | activated for the E-UTRAN capable UE) |
| eNodeB Address in Use | The IP address of the eNodeB currently used for S1-MME. |
| for S1-MME | |
| eNodeB UE S1AP ID | Unique identity of the UE within eNodeB. |
| MME UE S1AP ID | Unique identity of the UE within MME. |
| Subscribed UE-AMBR | The Maximum Aggregated uplink and downlink MBR values to be |
| | shared across all Non-GBR bearers according to the subscription of |
| | the user. |
| UE-AMBR | The currently used Maximum Aggregated uplink and downlink |
| | MBR values to be shared across all Non-GBR bearers. |
| EPS Subscribed | The charging characteristics for the UE e.g. normal, prepaid, flat |
| Charging | rate and/or hot billing. |
| Characteristics | |
| Subscribed RFSP Index | An index to specific RRM configuration in the E-UTRAN that is |
| | received from the HSS. |
| Subscribed Additional | An index to additional RRM configuration in the E-UTRAN that is |
| RRM Policy Index | received from the HSS |
| RFSP Index in Use | An index to specific RRM configuration in the E-UTRAN that is |
| | currently in use. |
| Additional RRM Policy | An index to additional RRM configuration in the E-UTRAN that is |
| Index in Use | currently in use |
| Trace reference | Identifies a record or a collection of records for a particular trace. |
| Trace type | Indicates the type of trace |
| Trigger id | Identifies the entity that initiated the trace |
| OMC identity | Identifies the OMC that shall receive the trace record(s). |
| URRP-MME | URRP-MME indicating that the HSS has requested the MME to |
| | notify the HSS regarding UE reachability at the MME |
| DL Data Buffer | When extended buffering of DL data has been invoked for UEs that |
| Expiration Time | uses power saving functions e.g. PSM, this time is when the buffer |
| | will expire in the Serving GW. |
| Suggested number of | Suggested number of buffered downlink packets at extended |
| buffered downlink | buffering. This is an optional parameter. |
| packets | |
| CSG Subscription Data | The CSG Subscription Data is associated lists of CSG IDs for the |
| | visiting PLMN and the equivalent PLMNs to the visiting PLMN, |
| | and for each CSG ID optionally an associated expiration date which |
| | indicates the point in time when the subscription to the CSG ID |
| | expires; an absent expiration date indicates unlimited subscription. |
| | For a CSG ID that can be used to access specific PDNs via Local IP |
| | Access, the CSG ID entry includes the corresponding APN(s). |
| LIPA Allowed | Specifies whether the UE is allowed to use LIPA in this PLMN. |
| IAB-Operation | Indicates that the subscriber is allowed for IAB-operation. |
| Allowed | |
| Subscribed Periodic | Indicates a subscribed Periodic RAU/TAU Timer value. |
| RAU/TAU Timer | |
| MPS CS priority | Indicates that the UE is subscribed to the eMLPP or 1x RTI priority |
| | service in the CS domain. |
| MPS EPS priority | Indicates that the UE is subscribed to MPS in the EPS domain. |

TABLE 3

| Voice Support Match | An indication whether the UE radio capabilities are compatible with |
|---|---|
| indicator | the network configuration (e.g. whether the SRVCC and frequency |
| | support by the UE matches those that the network relies upon for |
| | voice coverage). The MME uses it as an input for setting the IMS |
| | voice over PS Session Supported Indication. |
| Homogenous Support | Indicates per UE if “IMS Voice over PS Sessions” is |
| of IMS Voice over PS | homogeneously supported in all TAs in the serving MME or |
| Sessions | homogeneously not supported, or, support is |
| | non-homogeneous/unknown, see clause 4.3.5.8A. |
| UE Radio Capability | Information used by the eNodeB to determine the timing of paging |
| for Paging information - | events and/or enhance the paging towards the UE (see clause |
| WB-E-UTRAN | 5.11.4). The UE Radio Capability for Paging information is defined |
| | in TS 36.413 [36]. |
| UE Radio Capability | Information used by the eNodeB to determine the timing of paging |
| for Paging information - | events and/or enhance the paging towards the UE (see clause |
| NB-IoT | 5.11.4). The UE Radio Capability for Paging information is defined |
| | in TS 36.413 [36]. |
| information On | Information sent by the eNodeB, and used by the MME when |
| Recommended Cells | paging the UE to help determining the eNodeBs to be paged as well |
| And eNodeBs For | as to provide the information on recommended cells to each of these |
| Paging | eNodeBs, in order to optimise the probability of successful paging |
| | while minimizing the signalling load on the radio path. |
| Paging Attempt Count | Information provided by the MME and used by the eNodeB to |
| | optimise signalling load and the use of network resources to |
| | successfully page a UE. |
| Information for | Information for Enhanced Coverage level and cell ID provided by |
| Enhanced Coverage | the last eNodeB the UE was connected to. |
| CE mode B Support | Indicates whether CE mode B is supported by the UE. The MME |
| indicator | receives this from eNodeB (see TS 36.413 [36]). |
| Enhanced Coverage | Specifies whether the UE is restricted to use enhanced coverage |
| Restricted | feature or not. |
| CE mode B Restricted | Specifies whether the UE is restricted to use CE mode B (i.e. |
| | Coverage Extension mode B) or not. |
| UE Usage Type | Indicates the usage characteristics of the UE for use with Dedicated |
| | Core Networks (see clause 4.3.25) |
| Group lD-list | List of the subscribed group(s) that the UE belongs to |
| Monitoring Event | Describes the monitoring event configuration information. See TS |
| Information Data | 23.682 [74] for more information. |
| Delay Tolerant | Indicates that the PDN connection is delay tolerant such that the |
| Connection | PDN GW supports holding the procedure, after receiving a reject |
| | with a cause indicating that UE is temporarily not reachable due to |
| | power saving, until the PDN GW receives a message indicating that |
| | the UE is available for end to end signalling |
| PDN Connection | Indicates whether the establishment of the PDN connection is |
| Restriction | restricted for the UE. |
| Acknowledgements of | Indicates whether acknowledgement of downlink NAS data PDUs |
| downlink NAS data | for Control Plane CIoT EPS Optimisation is disabled for this UE |
| PDUs | (enabled by default). |
| Service Gap Time | Used to set the Sen/ice Gap timer for Service Gap Control (see |
| | clause 4.3.17.9). |
| List of APN Rate | Indicates for each APN, the APN Rate Control Status (see clause |
| Control Statuses | 4.7.7.3). |
| WUS Assistance | Assistance information for determining the WUS group (see TS |
| information | 36.300 [5]). |

For each active PDN connection:

| | |
|---|---|
| APN in Use | The APN currently used. This APN shall be composed of the APN |
| | Network identifier and the default APN Operator Identifier, as |
| | specified in TS 23.063 [9], clause 9.1.2. Any received value in the |
| | APN Oi Replacement field is not applied here. |
| APN Restriction | Denotes the restriction on the combination of types of APN for the |
| | APN associated with this EPS bearer Context. |
| APN Subscribed | The subscribed APN received from the HSS. |
| PDN Type | lPv4, IPv6, lPv4v6, Non-IP or Ethernet. |
| SCEF ID | The IP address of the SCEF currently being used for providing PDN |
| | connection to the SCEF. |
| IP Address(es) | lPv4 address and/or IPv6 prefix |
| | NOTE: The MME might not have information on the allocated lPv4 |
| | address. Alternatively, following mobility involving a pre-release 8 |
| | SGSN, this lPv4 address might not be the one allocated to the UE. |
| Header Compression | ROHC configuration and context(s) for IP header compression for |
| Configuration | Control Plane CIoT EPS Optimisation. |
| EPS PDN Charging | The charging characteristics of this PDN connection, e.g. normal, |
| Characteristics | prepaid, flat-rate and/or hot billing. |

TABLE 4

| | |
|---|---|
| APN-OI Replacement | APN level APN-OI Replacement which has same role as UE level |
| | APN-OI Replacement but with higher priority than UE level |
| | APN-OI Replacement. This is an optional parameter. When |
| | available, it shall be used to construct the PDN GW FQDN instead |
| | of UE level APN-OI Replacement. |
| SIPTO permissions | Indicates whether the traffic associated with this APN is prohibited |
| | for SIPTO, allowed for SIPTO excluding SIPTO at the local |
| | network, allowed for SIPTO including SIPTO at the local network |
| | or allowed for SIPTO at the local network only. |
| Local Home Network | If SlPTO@LN is enabled for this PDN connection it indicates the |
| lD | identity of the |
| | Local Home Network to which the (H)eNB belongs. |
| LIPA permissions | Indicates whether the PDN can be accessed via Local IP Access. |
| | Possible values are: LIPA-prohibited, LIPA-only and |
| | LIPA-conditional. |
| WLAN offloadability | Indicates whether the traffic associated with this PDN Connection is |
| | allowed to be offloaded to WLAN using the WLAN/3GPP Radio |
| | Interworking feature or if it shall be kept on 3GPP access (see |
| | clause 4.3.23). The indication may contain separate values per RAT |
| | (E-UTRA and UTRA). |
| VPLMN Address | Specifies whether the UE is allowed to use the APN in the domain |
| Allowed | of the HPLMN only, or additionally the APN in the domain of the |
| | VPLMN. |
| PDN GW Address in | The IP address of the PDN GW currently used for sending control |
| Use (control plane) | plane signalling. |
| PDN GW TEID for | PDN GW Tunnel Endpoint identifier for the S5/S8 interface for the |
| S5/S8 (control plane) | control plane. (For GTP-based S5/S8 only). |
| MS Info Change | Need to communicate change in User Location Information to the |
| Reporting Action | PDN GW with this EPS bearer Context. |
| CSG information | Need to communicate change in User CSG information to the PDN |
| Reporting Action | GW with this EPS bearer Context. |
| | This field denotes separately whether the MME/SGSN are requested |
| | to send changes in User CSG Information for (a) CSG cells, (b) |
| | hybrid cells in which the subscriber is a CSG member and (c) |
| | hybrid cells in which the subscriber is not a CSG member. |
| Presence Reporting | Need to communicate a change of UE presence in Presence |
| Area Action | Reporting Area. This field denotes separately the PRA identifier(s), |
| | and the list(s) of the Presence Reporting Area elements (if provided |
| | by the PDN GW). The status (i.e. active or inactive) for each |
| | Presence Reporting Area is stored in the MME when dynamic |
| | resource handling for Presence Reporting Area is configured in the |
| | MME. |
| EPS subscribed QoS | The bearer level QoS parameter values for that APN's default bearer |
| profile | (QCI and ARP)(see clause 4.7.3) |
| Subscribed | The Maximum Aggregated uplink and downlink MBR values to be |
| APN-AMBR | shared across all Non-GBR bearers, which are established for this |
| | APN, according to the subscription of the user. |
| APN-AMBR | The Maximum Aggregated uplink and downlink MBR values to be |
| | shared across all Non-GBR bearers, which are established for this |
| | APN, as decided by the PDN GW. |
| PDN GW GRE Key for | PDN GW assigned GRE Key for the S5/S8 interface for the user |
| uplink traffic (user | plane for uplink traffic. (For PMIP-based S5/S8 only) |
| plane) | |
| Default bearer | Identifies the EPS Bearer id of the default bearer within the given |
| | PDN connection. |
| low access priority | Indicates that the UE requested low access priority when the PDN |
| | connection was opened. |
| | NOTE: The low access priority indicator is only stored for the |
| | purpose to be included in charging records. |
| PDN continuity at inter | Provides for this APN how to handle a PDN connection when UE |
| RAT mobility | the moves between “broadband” (WB-E-UTRAN and UTRAN) and |
| | “narrowband” (NB-IoT, GPRS, EC-GSM-IoT). Possible values are: |
| | maintain the PDN connection; disconnect the PDN connection with |
| | a reactivation request; disconnect PDN connection without |
| | reactivation request; or to leave it to local VPLMN policy. |

For each bearer within the PDN connection:

| | |
|---|---|
| EPS Bearer ID | An EPS bearer identity uniquely identifies an EPS bearer for one |
| | UE accessing via E-UTRAN |
| TI | Transaction Identifier |
| S-GW IP address for | IP address of the S-GW for the S1-u interface. Also IP address of |
| S1-u/S11-u | the S-GW for the S11-u interface if no separation of S1-U and |
| | S11-U is required. The S11-u interface is used for Control Plane |
| | CIoT EPS Optimisation. |
| S-GW IP address for | IP address of the S-GW for the S11-u interfaces if S11-u is |
| S11-u | separated from S1-u. The S11-u interface is used for Control Plane |
| | CIoT EPS Optimisation. |

TABLE 5

| | |
|---|---|
| S-GW TEID for | Tunnel Endpoint Identifier of the S-GW for the Si-u interface. Also |
| S1-u/S11-u | Tunnel Endpoint Identifier of the S-GW for the S11-u interface if |
| | no separation of S1-U and S11-U is required. The S11-u interface is |
| | used for Control Plane CloT EPS Optimisation. |
| S-GW TEID for S11-u | Tunnel Endpoint Identifier of the S-GW for the S11-u interface if |
| | S11-u is separated from S1-u. The S11-u interface is used for |
| | Control Plane CloT EPS Optimisation. |
| MME IP address for | MME IP address for the S11-u interface (Used by the S-GW). The |
| S11-u | S11-u interface is used for Control Plane CloT EPS Optimisation. |
| MME TEID for S11-u | MME Tunnel Endpoint Identifier for the S11-u interface (Used by |
| | the S-GW). The S11-u interface is used lor Control Plane CloT EPS |
| | Optimisation. |
| PDN GW TEID for | P-GW Tunnel Endpoint identifier for the S5/S8 interface for the |
| S5/S8 (user plane) | user plane. (Used for S-GW change only). |
| | NOTE: The PDN CW TEID is needed in MME context as S-GW |
| | relocation is triggered without interaction with the source S-GW, |
| | e.g. when a TAU occurs. The Target S-GW requires this |
| | information Element, so it must be stored by the MME. |
| PDN GW IP address | P GW IP address for user plane for the S5/S8 interface for the user |
| for S5/S8 (user plane) | plane. (Used for S-GW change only). |
| | NOTE: The PDN GW IP address for user plane is needed in MME |
| | context as S-GW relocation is triggered without interaction with the |
| | source S-GW, e.g. when a TAU occurs. The Target S GW requires |
| | this information Element, so it must be stored by the MME. |
| EPS bearer QoS | QCI and ARP |
| | optionally: GBR and MBR for GBR bearer |
| TFT | Traffic Flow Template. (For PMIP-based S5/S8 only) |
| Sewing | The Sewing PLMN-Rafe-Control limits the maximum number of |
| PLMN-Rate-Control | NAS Data PDUs per deci hour sent per direction (uplink/downlink) |
| | using the Control Plane CIoT EPS Optimisation for a PDN |
| | connection. |

TABLE 6

| Field | Description |
|---|---|
| SUPI | SUPI (Subscription Permanent Identifier) is the subscriber's |
| | permanent identity in 5GS. |
| Routing Indicator | UE's Routing Indicator that allows together with SUCI/SUPI |
| | Home Network Identifier to route network signalling to AUSF |
| | and UDM instances capable to serve the subscriber. |
| Home Network Public Key | UE's Network Public Key identifier that may be used together |
| identifier | with SUCI/SUPI Home Network Identifier and Routing |
| | Indicator to route network signalling to AUSF and UDM |
| | instances capable to serve the subscriber. |
| AUSF Group ID | The AUSF Group ID for the given UE. |
| UDM Group ID | The UDM Group ID for the UE. |
| PCF Group ID | The PCF Group ID for the UE. |
| SUPI-unauthenticated-indicator | This indicates whether the SUPI is unauthenticated. |
| GPSI | The GPSI(s) of the UE. The presence is dictated by its storage |
| | in the UDM. |
| 5G-GUTI | 5G Globally Unique Temporary Identifier. |
| PEI | Mobile Equipment Identity. |
| Internal Group ID-list | List of the subscribed internal group(s) that the UE belongs to. |
| UE Specific DRX Parameters | UE specific DRX parameters for E-UTRA and NR. |
| UE Specific DRX Parameters | UE Specific DRX Parameters for NB-IoT. |
| for NB-IoT | |
| UE MM Network Capability | Indicates the UE MM network capabilities. |
| 5GMM Capability | Includes other UE capabilities related to 5GCN or |
| | interworking with EPS. |
| Events Subscription | List of the event subscriptions by other CP NFs. Indicating the |
| | events being subscribed as well as any information on how to |
| | send the corresponding notifications. |
| LTE-M Indication | Indicates if the UE is a Category M UE. This is based on |
| | indication provided by the NG-RAN or by the MME at EPS to |
| | 5GS handover. |
| NR RedCap indication | Indicates if the UE is a NR RedCap UE. This is based on |
| | indication provided by the NG-RAN as specified in TS 23.501 |
| | [2]. |
| MO Exception Data Counter | MO Exception Data Counter used for Small Data Rate Control |
| | purposes, see clause 5.31.14.3 of TS 23.501 [2]. |
| AMF-Associated Expected UE | Indicates per UE the Expected UE Behaviour Parameters and |
| Behaviour parameters | their corresponding validity times as specified in clause |
| | 4.15.6.3. |
| Disaster Roaming | Indicates the UE is registered for Disaster Roaming service. |
| PLMN with disaster condition | This is the PLMN of the UE which has faced disaster |
| | condition. |
| SNPN Onboarding indication | Indicates that the UE is registered for onboarding in an SNPN. |

For the AM Policy Association:

| | |
|---|---|
| AM Policy Information | Information on AM policy provided by PCF. It includes the |
| | Policy Control Request Triggers and Access and mobility |
| | related policy information as described in clauses 6.1.2.5 and |
| | 6.5 of TS 23.503 [20] except RFSP Index in Use Validity |
| | Time. |
| PCF ID | The identifier of the PCF for AM Policy. In roaming, the |
| | identifier of V-PCF (NOTE 2). |

For the UE Policy Association:

| | |
|---|---|
| Trigger information | The Policy Control Request Triggers on UE policy provided |
| | by PCF. |
| PCF ID(s) | The identifier of the PCF for UE Policy. In roaming, the |
| | identifiers of both V-PCF and H-PCF (NOTE 1) (NOTE 2). |

For the UE NWDAF association:

| | |
|---|---|
| NWDAF ID(s) | Indicating the NWDAF ID(s) (instance ID(s) or Set ID(s)) |
| | used for the UE specific Analytics. |
| Subscription Correlation ID(s) | Active UE-related analytics subscription(s) for each given |
| | NWDAF ID. |
| Analytics ID(s) | Analytics ID(s) per NWDAF ID. |
| Analytics specific data | Additional information on the Analytics ID(s) the AMF is |
| | subscribed related to the UE specific Analytics, i.e. per |
| | Analytics ID it contains the following parameters: Analytics |
| | Filter Information, Target of Analytics reporting, Analytics |
| | Reporting info. |

Other information

| | |
|---|---|
| Subscribed RFSP Index | An index to specific RRM configuration in the NG-RAN that |
| | is received from the UDM. |
| RFSP Index in Use | An index to specific RRM configuration in the NG-RAN that |
| | is currently in use. |
| 5G access stratum time | The 5G access stratum time distribution indication to be |
| distribution indication | provided to RAN based on the 5G access stratum time |
| | distribution indication received from the PCF. |
| Uu time synchronization error | The Uu time synchronization error budget to be provided to |
| budget | RAN based on the Uu time synchronization error budget |
| | received from the PCF. |
| Clock quality detail level | It indicates whether and which clock quality information to |
| | provide to the UE and can take one of the following values |
| | “clock quality metrics” or “acceptable/not acceptable |
| | indication”. |

TABLE 7

| | |
|---|---|
| Clock quality | Indicates acceptable criteria for the UE based on the attributes |
| acceptance criteria | defined in Table 5.27.1.12-1 of TS 23.501 [2]. |
| UE-AMBR in serving | The UE-AMBR that has been sent to RAN (e.g. based on |
| network | subscribed UE-AMBR from UDM or UE-AMBR received from |
| | PCF) |
| List of | The list of UE-Slice-MBR if applicable. There is a single uplink and |
| UE-Slice-MBR(s) | a single downlink value per S-NSSAI. |
| MICO Mode indication | Indicates the MICO Mode for the UE. |
| Extended idle mode | Negotiated extended idle mode DRX parameters. |
| DRX Parameters | |
| Active Time Value for | UE specific Active Time value allocated by AMF for MICO mode |
| MICO mode | handling. |
| Strictly Periodic | An indication that UE shall perform the Periodic Registration |
| Registration Timer | Update in a strictly periodic time, see clause 5.31.7.5 of TS 23.501 |
| Indication | [2]. |
| Voice Support Match | An indication whether the UE radio capabilities are compatible with |
| indicator | the network configuration. The AMF uses it as an input for setting |
| | the IMS voice over PS Session Supported indication over 3GPP |
| | access. |
| Homogenous Support | Indicates per UE if “IMS Voice over PS Sessions” is |
| of IMS Voice over PS | homogeneously supported in all TAs in the serving AMF or |
| Sessions | homogeneously not supported, or, support is |
| | non-homogeneous/unknown, see clause 5.16.3.3 of TS 23.501 [2]. |
| UE Radio Capability | Information used by the NG-RAN to enhance the paging towards |
| for Paging Information | the UE (see clause 5.4.4.1 of TS 23.501 [2]). |
| Information On | information sent by the NG-RAN and used by the AMF when |
| Recommended Cells | paging the UE to help determining the NG-RAN nodes to be paged |
| And RAN nodes For | as well as to provide the information on recommended cells to each |
| Paging | of these NG-RAN nodes, in order to optimize the probability of |
| | successful paging while minimizing the signalling load on the radio |
| | path. |
| UE Radio Capability | information sent by the NG-RAN node and stored in the AMF. The |
| Information | AMF sends this information to the NG-RAN node within the UE |
| | context during transition to CM-CONNECTED state, except for |
| | NB-IoT when NB-IoT specific UE Radio Access Capability are sent |
| | instead. |
| UE Radio Capability ID | Pointer that uniquely identifies a set of UE Radio Capabilities in |
| | UCMF as defined in TS 23.501 [2]. |
| NB-IoT specific UE | NB-IoT specific UE radio access capabilities. |
| Radio Access | |
| Capability Information | |
| WUS Assistance | Assistance information for determining the WUS group (see TS |
| Information | 23.501 [2]). |
| Paging Subgrouping | UE indication of its capability to support NR paging subgrouping. |
| Support Indication | |
| AMF PEIPS Assistance | AMF assigned NR paging subgroup information for use in NR |
| Information | paging subgrouping (see TS 23.501 [2]) |
| SMSF Identifier | The identifier of the SMSF serving the UE in RM-REGISTERED |
| | state. |
| SMSF Address | The Address of the SMSF serving the UE in RM-REGISTERED |
| | state. (see clause 4.13.3.1). |
| SMS Subscription | Indicates subscription to any SMS delivery service over NAS |
| | irrespective of access type. |
| SEAF data | Master security information received from AUSF. |
| Last used EPS PLMN | The identifier of the last used EPS PLMN. |
| ID | |
| Paging Assistance Data | Paging Assistance Data for Enhanced Coverage level and cell ID |
| for CE capable UE | provided by the last NG-RAN the UE was connected to. |
| Enhanced Coverage | Specifies per PLMN whether CE mode B is restricted for the UE, or |
| Restricted Information | both CE mode A and CE mode B are restricted for the UE, or both |
| | CE mode A and CE mode B are not restricted for the UE. |
| NB-IoT Enhanced | Specifies per PLMN whether the Enhanced Coverage is restricted or |
| Coverage Restricted | not for the UE. |
| Information | |
| Service Gap Time | Used to set the Service Gap timer for Service Gap Control (see |
| | clause 5.31.16 of TS 23.501 [2]). |
| Running Service Gap | The time of expiry of a currently running Service Gap Timer (see |
| expiry time | clause 5.31.16 of TS 23.501 [2]). |
| NB-IoT UE Priority | Numerical value used by the NG-RAN to prioritise between UEs |
| | accessing via NB-IoT. |
| List of Small Data Rate | List of Small Data Rate Control Statuses by DNN and S-NSSAI for |
| Control Statuses | the released PDU Sessions, see clause 5.31.143 of TS 23.501 [2]. |
| List of APN Rate | Indicates for each APN, the APN Rate Control Status (see clause |
| Control Statuses | 4.7.7.3 of TS 23.401 [13]) received from an MME when mobility |
| | from EPC to 5GC occurs. This information is provided to the MME |
| | during 5GC to EPC mobility. |
| UE positioning | Information sent by the LMF and stored in the AMF. The AMF |
| capability | sends this information along with the location request to the LMF. |

TABLE 8
For each access type level context within the UE access and mobility context:

| Access Type | Indicates the access type for this context. |
|---|---|
| RM State | Registration management state. |
| UUAA-MM Status | Indicates the status of UUAA-MM if the AMF is configured to |
| | perform the UAV authentication/authorization at 5GS registration |
| | as described in clause 5.2.2 of TS 23.256 [80]. Possible states are |
| | “PENDING”, “SUCCESS”, “FAILED”. For status “PENDING” and |
| | “FAILED” the AMF rejects any PDU session establishment request |
| | from the UE for DNN and S-NSSAI that are used for UAS services. |
| Registration Area | Current Registration Area (a set of tracking areas in TAI List). |
| TAI of last Registration | TAI of the TA in which the last Registration Request was initiated. |
| User Location | Information on user location. |
| Information | |
| Mobility Restrictions | Mobility Restrictions restrict mobility handling or service access of |
| | a UE. It consists of RAT restriction, Forbidden area, Service area |
| | restrictions and Core Network type restriction. It may also contain |
| | an Allowed CAG list and optionally an indication whether the UE is |
| | only allowed to access SGS via CAG cells. Each entry in the |
| | Allowed CAG list may also be associated with validity conditions |
| | (NOTE 4). |
| Security Information | As defined in TS 33.501 [15]. |
| for CP | |
| Security Information | As defined in TS 33.501 [15]. |
| for UP | |
| Allowed NSSAI | Allowed NSSAI consisting of one or more S-NSSAIs for serving |
| | PLMN in the present Registration Area. |
| Mapping Of Allowed | Mapping Of Allowed NSSAI is the mapping of each S-NSSAI of |
| NSSAI | the Allowed NSSAI to the S-NSSAIs of the Subscribed S-NSSAIs. |
| Partially Allowed | Partially Allowed NSSAI consisting of one or more S-NSSAIs for |
| NSSAI | serving PLMN. An associated TA-list for each of the S-NSSAIs in |
| | the Partially Allowed NSSAI defines in which TAs the S-NSSAI |
| | may be used. |
| Mapping Of Partially | Mapping Of Partially Allowed NSSAI is the mapping of each |
| Allowed NSSAI | S-NSSAI of the Partially Allowed NSSAI to the S-NSSAIs of the |
| | Subscribed S-NSSAIs. |
| S-NSSAIs subject to | Subscribed S-NSSAIs which are subject to NSSAA procedure. |
| Network Slice-Specific | Also including the status, i.e. result, of the NSSAA if already |
| Authentication and | executed or whether the S-NSSAI is pending the completion of an |
| Authorization | NSSAA procedure. |
| Inclusion of NSSAI in | [Only for 3GPP access] it defines whether the UDM has indicated |
| RRC Connection | that the UE is allowed to include NSSAI in the RRC connection |
| Establishment Allowed | Establishment in clear text. |
| by HPLMN | |
| Access Stratum | Defines what NSSAI, if any, to include in the Access Stratum |
| Connection | connection establishment as specified in clause 5.15.9 of TS 23.501 |
| Establishment NSSAI | [2] |
| Inclusion Mode | |
| CM state for UE | Identifies the UE CM state (CM-IDLE, CM-CONNECTED) for UE |
| connected via | connected via N3IWF/TNGF |
| N3IWF/TNGF | |
| N2 address information | Identifies the N3IWF/TNGF to which UE is connected. Exists only |
| for N3IWF/TNGF | if CM state for UE connected via N3IWF/TNGF is CM |
| | CONNECTED. |
| AMF UE NGAP ID | Identifies the UE association over the NG interface within the AMF |
| | as defined in TS 38.413 [10]. This parameter exists only if CM state |
| | for the respective Access Type is CM-CONNECTED. |
| RAN UE NGAP ID | Identifies the UE association over the NG interface within the |
| | NG-RAN node as defined in TS 38.413 [10]. This parameter exists |
| | only if CM state for the respective Access Type is |
| | CM-CONNECTED. |
| Network Slice | The Network Slice Instances selected by 5GC for this UE. |
| Instance(s) | |
| URRP-AMF | UE Reachability Request Parameter contains a list of URRP-AMF |
| information | flags and associated authorised NF IDs. Each URRP-AMF flag |
| | indicates whether direct UE reachability notification has been |
| | authorised by the HPLMN towards the associated NF ID or not. |
| SoR Update Indicator | An indication whether the UDM requests the AMF to retrieve SoR |
| for Initial Registration | information when the UE performs NAS Registration Type “Initial |
| | Registration”. |
| SoR Update Indicator | An indication whether the UDM requests the AMF to retrieve SoR |
| for Emergency | information when the UE performs NAS Registration Type |
| Registration | “Emergency Registration”. |
| Charging | The Charging Characteristics as defined in Annex A of TS 32.256 |
| Characteristics | [71]. |

For each PDU Session level context:

| | |
|---|---|
| S-NSSAI(s) | The S-NSSAI(s) associated to the PDU Session. |
| DNN | The associated DNN for the PDU Session. |
| Network Slice Instance | The network Slice Instance information for the PDU Session |
| id | |
| PDU Session ID | The identifier of the PDU Session. |
| SMF Information | The associated SMF identifier and SMF address for the PDU |
| | Session. |
| | When an I-SMF is used, this additionally include the information |
| | correspond to an I-SMF. |

TABLE 9

| | |
|---|---|
| Access Type | The current access type for this PDU Session (fora MA PDU |
| | Session this may correspond to information indicating 2 Access |
| | Type). |
| EBI-ARP list | The allocated EBI and associated ARP pairs for this PDU session. |
| 5GSM Core Network | The UEs 5GSM Core Network Capability as defined in clause |
| Capability | 5.4.4b of TS 23.501 [2]. |
| SMF derived CN | These are PDU Session specific parameters received from the SMF |
| assisted RAN | and used by the AMF to derive the Core Network assisted RAN |
| parameters tuning | parameters tuning. |

NOTE 1:
The AMF transfers the PCF ID to the SMF during PDU Session Establishment. The SMF may select the PCF identified by the PCF ID as described in clause 6.3.7.1 of TS 23.501 [2]. In HR roaming case, the AMF transfers the identifier of H-PCF as described in clause 4.3.22.2. In LBO roaming case, the AMF transfers the identifier of V-PCF as described in clause 4.3.2.2.1.
NOTE 2:
The PCF ID in AM Policy Association information and the PCF ID in UE Policy Association Information should be the same in non-roaming case. The V-PCF ID in AM Policy Association information and the V-PCF ID in UE Policy Association Information should be the same in roaming case.
NOTE 3:
Not all the parameters stored at AMF are required to be transferred between AMFs during the inter-AMF mobility. The parameters which are required to be transferred between AMFs are defined in TS 29.518 [18].
NOTE 4:
The validity information is not provided to the NG-RAN. The AMF shall determine the CAG Identifier(s) to be provided to the NG-RAN in Allowed CAG list, by taking into consideration the validity information associated with the CAG Identifier(s). as described in clause 5.30.3 of TS 23.501 [2].

What is claimed is:

1. A method for handling, by a mobility management entity (MME)-ground, a user equipment (UE) context for satellite communication, the method comprising:
maintaining a UE context for a UE based on the UE registering with a network entity;
identifying at least one first MME-onboard each of which is in a corresponding satellite having possibility to serve the UE; and
sharing the UE context stored at the MME-ground with the at least one identified first MME-onboard.

2. The method of claim 1, wherein the MME-ground is configured to support a store and forward service in the satellite communication based on the synchronized UE context.

3. The method of claim 1, wherein the at least one first MME-onboard is identified based on a location of the UE.

4. The method of claim 1, wherein the UE context, stored at the MME-ground, is shared in response to determining that a feeder link is established between the MME-ground and the at least one first MME-onboard, where the feeder link includes a communication link between a onboard entity of a satellite and a ground network.

5. The method of claim 1, further comprising:
detecting that the UE context has changed from a first UE context to a second UE context;
identifying at least one second MME-onboard each of which is in a corresponding satellite having possibility to serve the UE, based on the detection; and
sharing the second UE context stored at the MME-ground with the at least one identified second MME-onboard.

6. The method of claim 1, further comprising:
detecting a change in a UE serving area;
identifying at least one third MME-onboard each of which is in a corresponding satellite having possibility to serve the UE based on the detection; and
sharing the UE context stored at the MME-ground (304) with the at least one identified third MME-onboard.

7. The method of claim 1, further comprising:
detecting a change in a UE serving area;
identifying at least one fourth MME-onboard each of which is in a corresponding satellite having possibility not to serve the UE based on the detection; and
deleting the UE context shared at the at least one identified fourth MME-onboard.

8. The method of claim 1, wherein a MME-onboard is configured to act as a slave node to the MME-ground, wherein the MME-ground has an address of a subset of the at least one MME-onboard, wherein the at least one MME-onboard serves the UE based on a location of the UE.

9. The method of claim 1, wherein the MME-ground includes an anchor node situated in a ground network which has the UE context, wherein the MME-ground synchronizes the UE context with the at least one first MME-onboard.

10. The method of claim 1, wherein the MME-ground is locally configured with information that indicates which the MME-onboard will serve in the serving area of the UE or is configured by at least one of: an operations and maintenance (O&M) entity and an Application Function (AF) entity through a service capabilities exposure function (SCEF) path.

11. The method of claim 1, wherein the UE context is created or changed in the at least one first MME-onboard, wherein the UE context is synchronized with the at least one first MME-onboard, based on the at least one MME-onboard connecting with a ground network.

12. An apparatus for a mobility management entity (MME)-ground for handling a user equipment (UE) context for satellite communication, the apparatus comprising:
memory storing instructions; and
at least one processor, comprising processing circuitry, wherein the instructions, when executed by the at least one processor, individually and/or collectively, cause the apparatus to:
maintain a UE context for a UE based on the UE registering with a network entity,
identify at least one first MME-onboard each of which is in a corresponding satellite having possibility to serve the UE; and
share the UE context stored at the MME-ground with the at least one identified first MME-onboard.

13. The apparatus of claim 12, wherein the MME-ground is configured to support a store and forward service in the satellite communication based on the synchronized UE context.

14. A non-transitory computer-readable storage medium storing instructions which, when executed by at least one processor, comprising processing circuitry, of an apparatus for a mobility management entity, MME,-ground, individually and/or collectively, cause the apparatus to:
maintain a UE context for a UE based on the UE registering with a network entity,
identify at least one first MME-onboard each of which is in a corresponding satellite having possibility to serve the UE; and
share the UE context stored at the MME-ground with the at least one identified first MME-onboard.

15. The non-transitory computer-readable storage medium of claim 14, wherein the MME-ground is configured to support a store and forward service in the satellite communication based on the synchronized UE context.

16. The apparatus of claim 12, wherein the at least one first MME-onboard is identified based on a location of the UE.

17. The apparatus of claim 12, wherein the UE context, stored at the MME-ground, is shared in response to determining that a feeder link is established between the MME-ground and the at least one first MME-onboard, where the feeder link includes a communication link between a onboard entity of a satellite and a ground network.

18. The apparatus of claim 12, wherein the instructions, when executed by the at least one processor, individually and/or collectively, cause the apparatus to:
detect that the UE context has changed from a first UE context to a second UE context;
identify at least one second MME-onboard each of which is in a corresponding satellite having possibility to serve the UE, based on the detection; and
share the second UE context stored at the MME-ground with the at least one identified second MME-onboard.

19. The apparatus of claim 12, wherein the instructions, when executed by the at least one processor, individually and/or collectively, cause the apparatus to:
detect a change in a UE serving area;
identify at least one third MME-onboard each of which is in a corresponding satellite having possibility to serve the UE based on the detection; and
share the UE context stored at the MME-ground (304) with the at least one identified third MME-onboard.

20. The apparatus of claim 12, wherein the instructions, when executed by the at least one processor, individually and/or collectively, cause the apparatus to:
detect a change in a UE serving area;
identify at least one fourth MME-onboard each of which is in a corresponding satellite having possibility not to serve the UE based on the detection; and
delete the UE context shared at the at least one identified fourth MME-onboard.
